(19) United States
(12) Patent Application Publication
(10) Pub. No.: US 2026/0269893 A1
(43) Pub. Date: Sep. 10, 2026

(54) USER EQUIPMENT (UE) CAPABILITIES AND LIGHT ADAPTATION

(71) Applicant: QUALCOMM Incorporated, San Diego, CA (US)

(72) Inventors: Diana MAAMARI, San Diego, CA (US); Gabi SARKIS, San Diego, CA (US); Weimin DUAN, San Diego, CA (US); Hyojin LEE, San Diego, CA (US); Yu ZHANG, San Diego, CA (US)

(21) Appl. No.: 19/071,735

(22) Filed: Mar. 5, 2025

(51) Int. Cl. H04B 7/06; H04W 72/232

(52) U.S. Cl. CPC H04B 7/0602; H04W 72/232

(57) ABSTRACT

Methods, systems, and devices for wireless communications are described. A user equipment (UE) may transmit a capability message indicating information about timing information, supported parameters, parameter values, signaling types, or any combination thereof supported by the UE for light adaptation. The UE may receive a control message indicating at least a first state corresponding to a bandwidth part and a second state corresponding to the bandwidth part. In some examples, the first and second states may correspond to a first and second quantity of antennas. In some examples, the first and second states may correspond to a first and second subset of parameter values. The UE may receive, based on the capability message, a downlink control information message indicating the first state. The UE may perform wireless communications via the bandwidth part according to the parameter values associated with the first state.

### TECHNICAL FIELD

The following relates to wireless communications, including user equipment (UE) capability for light adaptation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a capability message including an indication of timing information corresponding to an antenna switching procedure, receiving a control message indicating at least a first state corresponding to a bandwidth part and a second state corresponding to the bandwidth part, where the first state corresponds to a first quantity of antennas, and the second state corresponds to a second quantity of antennas, receiving, based on the capability message, a downlink control information (DCI) message indicating the first state of the bandwidth part (BWP), and performing wireless communications via the bandwidth part and at least the first quantity of antennas based on the downlink control information message, where a timing of the wireless communications is in accordance with the indication of timing information.

A UE for wireless communications is described. The UE may include one or more memories storing processor executable code, and one or more processors coupled with the one or more memories. The one or more processors may individually or collectively be operable to execute the code to cause the UE to transmit a capability message including an indication of timing information corresponding to an antenna switching procedure, receive a control message indicating at least a first state corresponding to a BWP and a second state corresponding to the BWP, where the first state corresponds to a first quantity of antennas, and the second state corresponds to a second quantity of antennas, receive, based on the capability message, a DCI message indicating the first state of the BWP, and perform wireless communications via the BWP and at least the first quantity of antennas based on the DCI message, where a timing of the wireless communications is in accordance with the indication of timing information.

Another UE for wireless communications is described. The UE may include means for transmitting a capability message including an indication of timing information corresponding to an antenna switching procedure, means for receiving a control message indicating at least a first state corresponding to a BWP and a second state corresponding to the BWP, where the first state corresponds to a first quantity of antennas, and the second state corresponds to a second quantity of antennas, means for receiving, based on the capability message, a DCI message indicating the first state of the BWP, and means for performing wireless communications via the BWP and at least the first quantity of antennas based on the DCI message, where a timing of the wireless communications is in accordance with the indication of timing information.

A non-transitory computer-readable medium storing code for wireless communications is described. The code may include instructions executable by one or more processors to transmit a capability message including an indication of timing information corresponding to an antenna switching procedure, receive a control message indicating at least a first state corresponding to a BWP and a second state corresponding to the BWP, where the first state corresponds to a first quantity of antennas, and the second state corresponds to a second quantity of antennas, receive, based on the capability message, a DCI message indicating the first state of the BWP, and perform wireless communications via the BWP and at least the first quantity of antennas based on the DCI message, where a timing of the wireless communications is in accordance with the indication of timing information.

In some examples of the method, UEs, and non-transitory computer-readable medium described herein, the indication of timing information includes an indication of a first timeline of a set of candidate timelines and the timing of the wireless communications may be in accordance with the indicated first timeline.

Some examples of the method, UEs, and non-transitory computer-readable medium described herein may further include operations, features, means, or instructions for setting a subset of antennas that may be not utilized in the first state into a low power state based on the indication of the timing information, the subset of antennas including a difference between the first quantity of antennas and the second quantity of antennas, where an offset between receiving a grant of resources for the wireless communications and performing the wireless communications satisfies a threshold amount of time in accordance with the indication of the timing information.

In some examples of the method, UEs, and non-transitory computer-readable medium described herein, the indication of timing information includes at least one threshold offset value between receiving a grant of resources for the wireless communications and performing the wireless communications.

Some examples of the method, UEs, and non-transitory computer-readable medium described herein may further include operations, features, means, or instructions for maintaining a subset of antennas that may be not utilized in the first state into a low power state based on the indication of the timing information, the subset of antennas including a difference between the first quantity of antennas and the second quantity of antennas, where an offset between receiving a grant of resources for the wireless communications and performing the wireless communications satisfies a threshold amount of time in accordance with the indication of the timing information.

Some examples of the method, UEs, and non-transitory computer-readable medium described herein may further include operations, features, means, or instructions for detecting that a delay corresponding to the wireless communications exceeds a threshold, transmitting a delay status report including an indication of updated timing information based on the detecting, and performing additional wireless communications, where a timing of the additional wireless communications may be in accordance with the indication of the updated timing information.

Some examples of the method, UEs, and non-transitory computer-readable medium described herein may further include operations, features, means, or instructions for detecting that buffer status report or a logical channel priority exceeds a threshold, transmitting a delay status report including an indication of updated timing information based on the detecting, and performing additional wireless communications, where a timing of the additional wireless communications may be in accordance with the indication of the updated timing information.

Some examples of the method, UEs, and non-transitory computer-readable medium described herein may further include operations, features, means, or instructions for transmitting a control message including an indication of updated timing information, where performing wireless communications may be based on the updated timing information.

Some examples of the method, UEs, and non-transitory computer-readable medium described herein may further include operations, features, means, or instructions for receive a control message including an indication of updated timing information, where performing wireless communications may be based on the updated timing information.

A method for wireless communications by a UE is described. The method may include transmitting a capability message indicating a set of parameters for which the UE supports switching between one or more states of a BWP, receiving a control message indicating at least a first state corresponding to the BWP and a second state corresponding to the BWP, where the first state corresponds to a first subset of one or more parameter values of the set of parameters, and the second state corresponds to a second subset of one or more parameter values of the set of parameters, based on the capability message, receiving, based on the capability message, a DCI message indicating the first state of the BWP, and performing wireless communications via the BWP and using the first subset of one or more parameter values based on the DCI message.

A UE for wireless communications is described. The UE may include one or more memories storing processor executable code, and one or more processors coupled (e.g., operatively, communicatively, functionally, electronically, or electrically) with the one or more memories. The one or more processors may individually or collectively be operable to execute the code (e.g., directly, indirectly, after pre-processing, without pre-processing) to cause the UE to transmit a capability message indicating a set of parameters for which the UE supports switching between one or more states of a BWP, receive a control message indicating at least a first state corresponding to the BWP and a second state corresponding to the BWP, where the first state corresponds to a first subset of one or more parameter values of the set of parameters, and the second state corresponds to a second subset of one or more parameter values of the set of parameters, based on the capability message, receive, based on the capability message, a DCI message indicating the first state of the BWP, and perform wireless communications via the BWP and using the first subset of one or more parameter values based on the DCI message.

Another UE for wireless communications is described. The UE may include means for transmitting a capability message indicating a set of parameters for which the UE supports switching between one or more states of a BWP, means for receiving a control message indicating at least a first state corresponding to the BWP and a second state corresponding to the BWP, where the first state corresponds to a first subset of one or more parameter values of the set of parameters, and the second state corresponds to a second subset of one or more parameter values of the set of parameters, based on the capability message, means for receiving, based on the capability message, a DCI message indicating the first state of the BWP, and means for performing wireless communications via the BWP and using the first subset of one or more parameter values based on the DCI message.

A non-transitory computer-readable medium storing code for wireless communications is described. The code may include instructions executable by one or more processors (e.g., directly, indirectly, after pre-processing, without pre-processing) to transmit a capability message indicating a set of parameters for which the UE supports switching between one or more states of a BWP, receive a control message indicating at least a first state corresponding to the BWP and a second state corresponding to the BWP, where the first state corresponds to a first subset of one or more parameter values of the set of parameters, and the second state corresponds to a second subset of one or more parameter values of the set of parameters, based on the capability message, receive, based on the capability message, a DCI message indicating the first state of the BWP, and perform wireless communications via the BWP and using the first subset of one or more parameter values based on the DCI message.

In some examples of the method, UEs, and non-transitory computer-readable medium described herein, the set of parameters include time domain parameters, frequency domain parameters, antenna domain parameters, or any combination thereof.

In some examples of the method, UEs, and non-transitory computer-readable medium described herein, the capability message further includes a bitmap, each codepoint of the bitmap corresponding to a candidate set of parameters of a set of multiple candidate sets of parameters.

In some examples of the method, UEs, and non-transitory computer-readable medium described herein, a first portion of the set of parameters corresponds to the first state, and a second portion of the set of parameters corresponds to the second state.

In some examples of the method, UEs, and non-transitory computer-readable medium described herein, the capability message includes an indication of whether the UE supports dynamic switching between states, semi-static switching between states, or both.

In some examples of the method, UEs, and non-transitory computer-readable medium described herein, the capability message includes an indication of a quantity of states corresponding to the BWP among which the UE may be capable of switching, an indication of a threshold timing corresponding to switching among the quantity of states, or any combination thereof.

In some examples of the method, UEs, and non-transitory computer-readable medium described herein, the capability message includes an indication of one or more scheduling restrictions and the one or more scheduling restrictions may be based on respective slot types.

In some examples of the method, UEs, and non-transitory computer-readable medium described herein, the capability message includes an indication of a signaling type for which the UE supports switching among two or more states corresponding to the BWP while satisfying one or more scheduling restrictions.

In some examples of the method, UEs, and non-transitory computer-readable medium described herein, the capability message indicates one or more parameters that the UE supports for multiple states corresponding to the BWP.

In some examples of the method, UEs, and non-transitory computer-readable medium described herein, the control message indicates whether one or more scheduling thresholds apply to downlink communications, uplink communications, communications per band, or any combination thereof.

A method for wireless communications by a UE is described. The method may include receiving a control message indicating at least a first state of two or more states corresponding to a BWP and a second state of the two or more states corresponding to the BWP, where each state is associated with a set of parameter values, communicating in accordance with the first state and a first set of parameter values or the second state and a second set of parameters in a radio resource control (RRC) connected mode, receiving a radio resource control connection release message indicating a first state of two or more states, reconnecting to a network entity according to the first state indicated in the connection release message, and communicating in accordance with the first state indicated in the connection release message in accordance with the reconnecting.

A UE for wireless communications is described. The UE may include one or more memories storing processor executable code, and one or more processors coupled (e.g., operatively, communicatively, functionally, electronically, or electrically) with the one or more memories. The one or more processors may individually or collectively be operable to execute the code (e.g., directly, indirectly, after pre-processing, without pre-processing) to cause the UE to receive a control message indicating at least a first state of two or more states corresponding to a BWP and a second state of the two or more states corresponding to the BWP, where each state is associated with a set of parameter values, communicate in accordance with the first state and a first set of parameter values or the second state and a second set of parameters in a RRC connected mode, receive a RRC connection release message indicating a first state of two or more states, reconnect to a network entity according to the first state indicated in the connection release message, and communicate in accordance with the first state indicated in the connection release message in accordance with the reconnecting.

Another UE for wireless communications is described. The UE may include means for receiving a control message indicating at least a first state of two or more states corresponding to a BWP and a second state of the two or more states corresponding to the BWP, where each state is associated with a set of parameter values, means for communicating in accordance with the first state and a first set of parameter values or the second state and a second set of parameters in a RRC connected mode, means for receiving a RRC connection release message indicating a first state of two or more states, means for reconnecting to a network entity according to the first state indicated in the connection release message, and means for communicating in accordance with the first state indicated in the connection release message in accordance with the reconnecting.

A non-transitory computer-readable medium storing code for wireless communications is described. The code may include instructions executable by one or more processors (e.g., directly, indirectly, after pre-processing, without pre-processing) to receive a control message indicating at least a first state of two or more states corresponding to a BWP and a second state of the two or more states corresponding to the BWP, where each state is associated with a set of parameter values, communicate in accordance with the first state and a first set of parameter values or the second state and a second set of parameters in a RRC connected mode, receive a RRC connection release message indicating a first state of two or more states, reconnect to a network entity according to the first state indicated in the connection release message, and communicate in accordance with the first state indicated in the connection release message in accordance with the reconnecting.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports UE capabilities and light adaptation in accordance with one or more aspects of the present disclosure.

FIG. 2 shows an example of a wireless communications system that supports UE capabilities and light adaptation in accordance with one or more aspects of the present disclosure.

FIG. 3 shows an example of a wireless communications system that supports UE capabilities and light adaptation in accordance with one or more aspects of the present disclosure.

FIG. 4 shows an example of timelines that supports UE capabilities and light adaptation in accordance with one or more aspects of the present disclosure.

FIG. 5 shows an example of a resource allocation that supports UE capabilities and light adaptation in accordance with one or more aspects of the present disclosure.

FIG. 6 shows an example of timelines that supports UE capabilities and light adaptation in accordance with one or more aspects of the present disclosure.

FIG. 7 shows an example of states within a (BWP) that supports UE capabilities and light adaptation in accordance with one or more aspects of the present disclosure.

FIG. 8 shows an example of a process flow that supports UE capabilities and light adaptation in accordance with one or more aspects of the present disclosure.

FIG. 9 shows an example of a process flow that supports UE capabilities and light adaptation in accordance with one or more aspects of the present disclosure.

FIG. 10 shows an example of a process flow that supports UE capabilities and light adaptation in accordance with one or more aspects of the present disclosure.

FIGS. 11 and 12 show block diagrams of devices that support UE capabilities and light adaptation in accordance with one or more aspects of the present disclosure.

FIG. 13 shows a block diagram of a communications manager that supports UE capabilities and light adaptation in accordance with one or more aspects of the present disclosure.

FIG. 14 shows a diagram of a system including a device that supports UE capabilities and light adaptation in accordance with one or more aspects of the present disclosure.

FIGS. 15 through 17 show flowcharts illustrating methods that support UE capabilities and light adaptation in accordance with one or more aspects of the present disclosure.

### DETAILED DESCRIPTION

In some wireless communications systems, adaptation of one or more parameters over time may improve wireless communications between two entities. For example, time adaptation, frequency adaptation, antenna adaptation, and other types of adaptation may save energy at a user equipment (UE) or otherwise improve power conservation or communication reliability at the UE. In some cases, BWP (BWP) switching (e.g., such as in new radio) may enable adaptation of time, frequency, antennas, and more. However, fully switching between a first BWP (e.g., an a full set of configurable parameters corresponding to the first BWP) and a second BWP (e.g., and a second set of configurable parameters corresponding to the second BWP) may require an extensive reconfiguration at the UE, which may be associated with long switching times, large overhead, and increased likelihood of out-of-sync (OOS) scenarios. This may result in increased latency, failed communications, and poor user experience. To support adaptation of parameters over time, but reduce the complexity, switching time, or other effects of such adaptation, a wireless communications system may support light adaptation (e.g., which may refer to switching between states of a single BWP configuration, each state corresponding to a different set of parameter values for the BWP configuration).

For example, the UE may receive a configuration common between two or more light adaptation states within a BWP. The UE may also receive an indication of a set of parameter values for each of the light adaptation states within the BWP, such that the UE may enter either state based on an indication (e.g., rather than a full reconfiguration).

The techniques, methods, and devices described herein may enable a UE to indicate capabilities and perform light adaptations. In some examples, the UE may transmit a capability message indicating information about timing information, supported parameters, parameter values, signaling types, or any combination thereof that the UE supports for light adaptation. The UE may receive a control message indicating at least a first state corresponding to a BWP and a second state corresponding to the BWP. The network may switch the UE between states, but may configure the states to satisfy one or more of the capabilities reported by the UE. The capability information may include information regarding restricted scheduling timing, power capabilities, signaling types or slot types corresponding to activation or scheduling in one or more states, how many states the UE supports, sub-capabilities corresponding to indicating capabilities, and other examples.

In some examples, the first and second states may correspond to a first and second quantity of antennas. The UE may report timing information indicating whether the UE supports fast or slow switching times between using a smaller quantity of active antennas and a large quantity of the active antennas. If the UE reports that it is capable of a faster switching timeline (e.g., in which case the UE may maintain one or more unused antennas in an active state), then the network entity may schedule communications (e.g., for a larger quantity of antennas even if the UE is currently in a state configured to use a smaller quantity of active antennas) with a small scheduling offset. However, if the UE reports that it is capable of the slower switching timeline (e.g., in which case the UE may put some unused active antennas into a low power state to conserve power), then the network entity may refrain from scheduling wireless communications with a short scheduling time (e.g., same-slot scheduling).

In some examples, the UE may communicate in a connected state via one or more of the configured states, and the network entity may then release the UE from the connected state. In such examples, the network entity may include, in a RRC connection release message, an indication of which state the UE should use to reconnect with the network during a next connection procedure. The UE may utilize the indicated state during a subsequent connection procedure.

Aspects of the disclosure are initially described in the context of wireless communications systems. Aspects of the disclosure are further illustrated by and described with reference to wireless communications systems, timelines, and process flows. Aspects of the disclosure are further illustrated by and described with reference to apparatus diagrams, system diagrams, and flowcharts that relate to the UE capability for light adaptation.

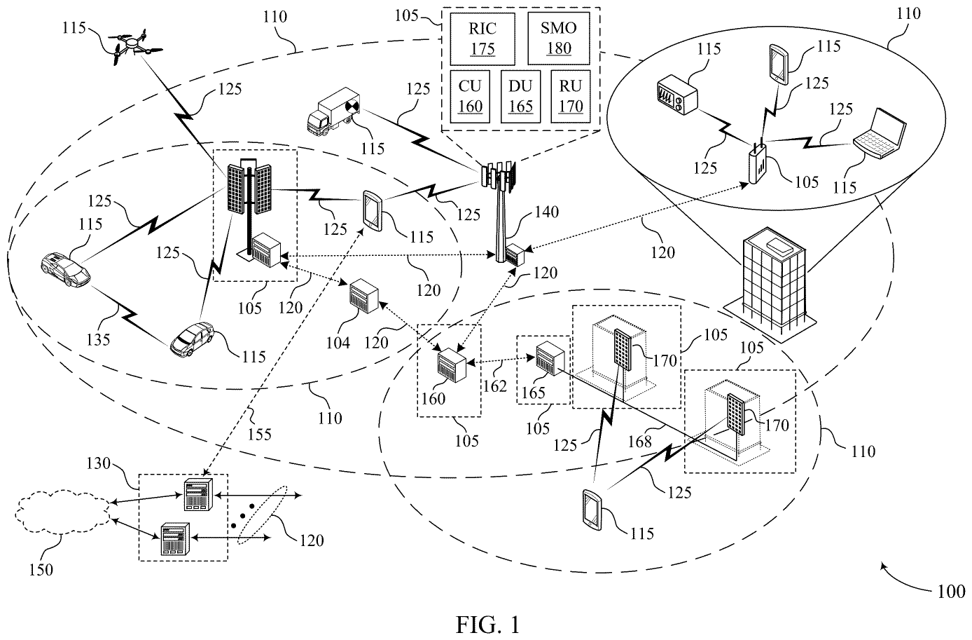

FIG. 1 shows an example of a wireless communications system 100 that supports UE capabilities and light adaptation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115—and the network entity 105 may establish the communication link(s) 125. The coverage area 110 may be an example of a geographic area over which a network entity 105—and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115—are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105—also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support UE capabilities and light adaptations described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105—and the network equipment including macro eNBs or gNBs, small cell eNBs or gNBs, or relay base stations, among other examples, as shown in FIG. 1.

The UEs 115—and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105—and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115—and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105—and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105—along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115—and a network entity 105 or a core network 130 supporting radio bearers for user plane data. A PHY layer may map transport channels to physical channels.

The UEs 115—and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, adaptation of one or more parameters over time may improve wireless communications between two entities. For example, time adaptation, frequency adaptation, antenna adaptation, and other types of adaptation may save energy at a user equipment (UE) or otherwise improve power conservation or communication reliability at the UE. In some cases, BWP (BWP) switching (e.g., such as in new radio) may enable adaptation of time, frequency, antennas, and more. However, fully switching between a first BWP (e.g., an a full set of configurable parameters corresponding to the first BWP) and a second BWP (e.g., and a second set of configurable parameters corresponding to the second BWP) may require an extensive reconfiguration at the UE, which may be associated with long switching times, large overhead, and increased likelihood of out-of-sync (OOS) scenarios. This may result in increased latency, failed communications, and poor user experience. To support adaptation of parameters over time, but reduce the complexity, switching time, or other effects of such adaptation, a wireless communications system may support light adaptation (e.g., which may refer to switching between states of a single BWP configuration, each state corresponding to a different set of parameter values for the BWP configuration).

For example, the UE may receive a configuration common between two or more light adaptation states within a BWP. The UE may also receive an indication of a set of parameter values for each of the light adaptation states within the BWP, such that the UE may enter either state based on an indication (e.g., rather than a full reconfiguration).

The techniques, methods, and devices described herein may enable a UE to indicate capabilities and perform light adaptations. In some examples, the UE may transmit a capability message indicating information about timing information, supported parameters, parameter values, signaling types, or any combination thereof that the UE supports for light adaptation. The UE may receive a control message indicating at least a first state corresponding to a BWP and a second state corresponding to the BWP. The network may switch the UE between states, but may configure the states to satisfy one or more of the capabilities reported by the UE. The capability information may include information regarding restricted scheduling timing, power capabilities, signaling types or slot types corresponding to activation or scheduling in one or more states, how many states the UE supports, sub-capabilities corresponding to indicating capabilities, and other examples.

In some examples, the first and second states may correspond to a first and second quantity of antennas. The UE may report timing information indicating whether the UE supports fast or slow switching times between using a smaller quantity of active antennas and a large quantity of the active antennas. If the UE reports that it is capable of a faster switching timeline (e.g., in which case the UE may maintain one or more unused antennas in an active state), then the network entity may schedule communications (e.g., for a larger quantity of antennas even if the UE is currently in a state configured to use a smaller quantity of active antennas) with a small scheduling offset. However, if the UE reports that it is capable of the slower switching timeline (e.g., in which case the UE may put some unused active antennas into a low power state to conserve power), then the network entity may refrain from scheduling wireless communications with a short scheduling time (e.g., same-slot scheduling).

In some examples, the UE may communicate in a connected state via one or more of the configured states, and the network entity may then release the UE from the connected state. In such examples, the network entity may include, in a RRC connection release message, an indication of which state the UE should use to reconnect with the network during a next connection procedure. The UE may utilize the indicated state during a subsequent connection procedure.

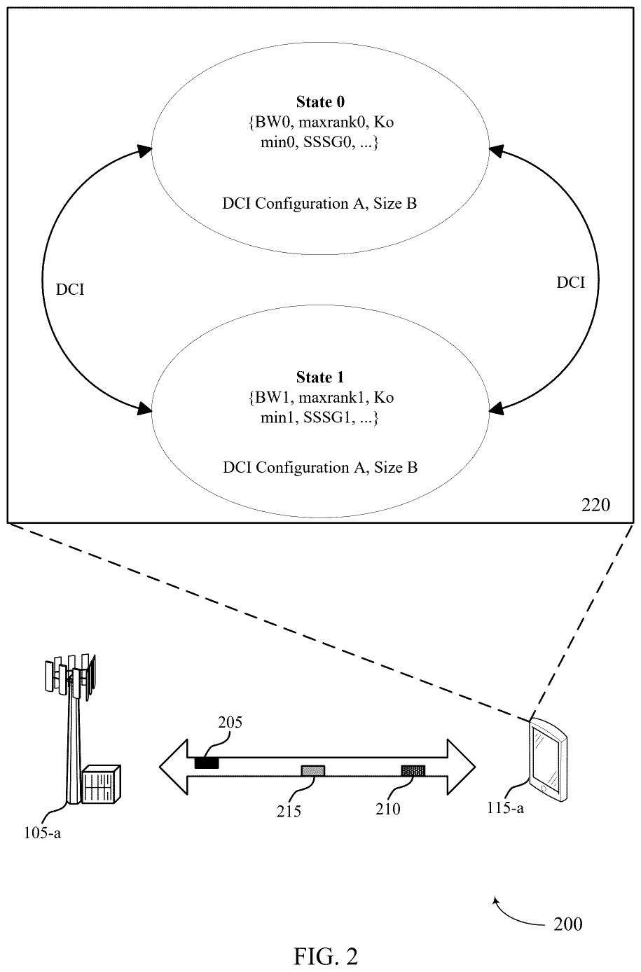

FIG. 2 shows an example of a wireless communication system 200 that supports UE capabilities and light adaptations in accordance with one or more aspects of the present disclosure. The wireless communications system 200 may implement, or be implemented by, aspects of the wireless communications system 100. For example, the UE 115-a and the network entity 105-a may be examples of corresponding devices described with reference to FIG. 1.

In some wireless communications systems, adaptation may improve wireless communications between two entities. For example, time adaptation, frequency adaptation, antenna adaptation, and other types of adaptation may save energy at a user equipment (UE). In some cases, BWP (BWP) switching (e.g., such as in new radio) may enable adaptation of time, frequency, antennas, and more.

BWP switching may enable fast adaptation of radio parameters with low-signaling overhead (e.g., such as the BWP concept as introduced in new radio (NR)). BWPs may allow for flexible spectrum assignment for a UE that is different from a carrier bandwidth. For example, the UE could be configured per BWP for downlink and uplink. RRC parameters may be organized in a BWP container such that the parameters and parameter values may be updated according to the BWP configuration. Such configurability may simplify switching parameters that impact UE power.

For example, the UE may receive a BWP configuration in which the UE is to change a monitored bandwidth from 20 MHz to 100 MHz when a large amount of data is to be transmitted to the UE. A BWP change may happen via RRC signaling, DCI (DCI) signaling, or with expiry of BWP inter-arrival time (IAT), among other examples. Many such configurations may be per BWP, which provides some flexibility (e.g., in wireless communications) but may come with a cost. For example, there may be a higher complexity at the UE associated with a BWP switch due to a reconfiguration of registers that is associated with a BWP switch.

Additionally, there may be a high penalty for an out-of-sync (OOS) active BWP between a network entity and the UE. OOS scenarios may occur due to naturally missed switching DCI, physical uplink shared channel discontinuous transmission (PUSCH DTX), or other conflict windows. For example, OOS scenarios may occur when a network entity switches to a new BWP while the UE remains configured to use the old BWP. Similarly, OOS scenarios may occur when the UE switches to a new BWP, while the network entity remains in the old BWP. In such cases, the DCI size and fields may change, making the DCI undecodable by the UE.

In some cases, a BWP switch may be associated with long switching times. For example, BWP switching (e.g., as designed in Rel-15) may function as a way to change a large number of RRC parameters (e.g., including DCI parameters, CORESETs). BWPs may not be switched often, resulting in lack of flexibility. When BWPs are switched, the UE may expend time and processing resources to switch the large quantity of parameters associated with the switch. For example, if there is a long timeline for reconfiguration to the new BWP, the network may switch BWPs before the UE (or vice versa), resulting in an OOS situation. Thus, the long timelines and high penalty for OOS may result in increased latency, failed communications, and poor user experience.

In some cases, a parameter switching framework for smaller quantities of parameters may reduce the penalty of OOS, and may limit the scope of parameters that are adapted to reduce switching time. Such a framework may be referred to as light adaptation and may not support full adaptation (e.g., light adaptation may include switching a subset of parameters within a given BWP configuration). A UE may receive a BWP configuration (e.g., including a full set of parameter values), but may perform light adaptation (e.g., switching only a subset of one or more of the parameter values configured with the BWP). For example, a BWP configuration may include an indication of multiple states (e.g., state 0 and state 1). Each state may be included within a given BWP configuration. State 0 may include a first subset of parameter values for a set of parameters, and state 1 may similarly include a second subset of parameter values for the same set of parameters.

Thus, as described herein, light adaptation may refer to a scenario in which a BWP is configured with multiple states. A first state of the BWP may correspond to a first subset of parameters or parameter values of the BWP, and a second state of the BWP may correspond to a second subset of parameters or parameter values of the BWP. A DCI may trigger a switch between the first state (e.g., the first set of parameter values) and the second state (e.g., the second set of parameter values) without a full BWP reconfiguration.

In some cases, the extent of an adaptation may vary, which results in varying degrees of flexibility at the UE and a range of potential switching times. For example, a full RRC reconfiguration of a BWP may result in high overhead costs and may result in high latency (e.g., the UE may take a long time to switch from the existing BWP configuration to the reconfiguration), while allowing the UE flexibility to adapt to a scenario with high specificity. A DCI triggered full BWP switch may support less flexibility with shorter switching times than a full RRC reconfiguration. A DCI based adaptation may allow less flexibility with shorter switching times than a DCI full BWP switch. Alternatively, a DCI-based light adaptation may enable short switching times between the existing configuration and the reconfiguration while allowing some flexibility in the UE adaptation (e.g. to a set of conditions, a scenario, a use case, or a deployment).

In some examples, a light adaptation may be triggered by DCIs having the same DCI size and DCI fields. Such light adaptations may include adaptations in bandwidth, number of active antennas, maximum rank, timeline, minimum scheduling offset, or search space periodicity (e.g., with no possibility of changing CORESET). For cases of light adaptation, the switching between a first state and a second state may be associated with a scheduling delay (e.g., K0 or K2 may be greater than 0), or same-slot scheduling may be possible according to active adaptation parameters (e.g., K0 or K2 may equal 0). Thus, the DCI size and fields may remain unchanged throughout the adaptation, which may enable the UE to decode DCI when the network entity and the UE experience OOS. Additionally, the unchanged DCI size and fields may reduce the amount of reprogramming or processing needed in the UE during the adaptation, and thus reduce the switching time of the light adaptation.

The techniques, methods, and devices described herein may enable light adaptation in various scenarios.

There may be some operation scenarios in which the UE benefits from performing a flexible light adaptation (e.g., instead of a full adaptation or bundled light adaptation), where parameter values within a configuration are updated based on one or more states. Adaptations in time, frequency, and antenna use under the light adaptation framework may save UE energy. For example, the UE may perform a flexible light adaptation in some operation scenarios to save energy, reduce latency, minimize the consequences of OOS, or improve wireless communications. Such flexible light adaptation may facilitate dynamic UE implementation or configuration in different scenarios.

As described further herein, to support flexible light adaptation, the UE 115-a may indicate what aspects of a BWP can be lightly adapted and may switch between one or more states of the BWP. For example, the UE 115-a may transmit a capability message 205 that indicates a set of parameters, and the UE 115-a may support switching between the states for the set of parameters. The UE 115-a may receive a control message 210 indicating one or more states corresponding to the BWP, and each state may correspond to a subset of parameter values associated with the parameters indicated in the capability message 205. In such cases, the UE 115-a may receive a DCI message 215 based on the capability message 205 that indicates a state of the BWP. In this way, the UE 115-a may switch to the indicated state of the BWP and perform wireless communications via the BWP using the subset of parameter values associated with the indicated state of the BWP.

For example, the network entity 105-a may configure the UE 115-a with a configuration 220. Configuration 220 may include BWP configuration information, including two or more states of a BWP (e.g., State 0 and State 1) based on a DCI (e.g., a DCI message 215). The DCI may be the same size and may include the same fields regardless of whether it indicates state 0 or state 1. The DCI configuration may not change between state 0 and state 1 (e.g., DCI configuration A). State 0 and state 1 may include or correspond to a common set of parameters and parameter values (e.g., a parent configuration, such as the BWP configuration). State 0 may correspond to a first subset of parameters with a first set of parameter values corresponding to state 0 (e.g., BW0, maxrank0, Ko min0, SSSG0), and state 1 may correspond to a second subset of parameters with a second set of parameter values corresponding to state 1 (e.g., BW1, maxrank1, Ko min1, SSSG1). In some cases, the UE 115-a may receive a DCI indicating for the UE 115-a to switch to state 0 of the BWP. In some cases, the UE 115-a may receive a DCI indicating for the UE 115-a to switch to state 1 of the BWP (e.g., from state 0).

Flexible light adaptation may allow for various options regarding which parameters are selected for an adaptation and in turn, which parameter values are changed between states. In some examples, the flexible light adaptation may include a grouping of parameters for adaptation in different domains (e.g., time, frequency, or antenna domains). In some examples, flexible light adaptation may include individual parameters for adaptation in different domains (e.g., time, frequency, or antenna domains). Additionally, or alternatively, flexible light adaptation may include parameters with different combinations of adaptation in each domain (e.g., time, frequency, or antenna domains).

For example, flexible adaptation may support a scenario in which a group of parameters are adapted in the time domain, and individual parameters are adapted in the frequency and antenna domain. In such an example, the set of parameters in the capability message 205 may include an indication of a group of parameters for adaptation in the time domain, in addition to parameters for adaptation in the frequency and antenna domain. The states indicated in the control message 210 may include different parameter values for the set of parameters indicated in the capability message 205 (e.g., state 0 and state 1 may be configured to adapt the parameters reported by the UE 115-a). The UE 115-a may receive the DCI message 215 indicating one of the states in the control message 210, and the UE 115-a may switch to the indicated state of the BWP to perform wireless communications via the BWP.

In some cases of flexible light adaptation, the UE 115-a may report a capability for each aspect of light adaptation in the capability message 205. For example, the UE 115-a may report a capability for a time domain adaptation (e.g., the UE 115-a may be able to keep data in the buffer for a long time), a frequency domain adaptation (e.g., bandwidth), an antenna domain adaptation, or any combination thereof, among other examples. Within each aspect of light adaptation, the UE 115-a may report additional detailed capabilities (e.g., more granular capability reporting). For example, for receiver adaptation, UE may report a capability to switch from 4 antennas to 1 antenna, or to switch from 4 antennas to 2 antennas. Such examples of capability reporting may be associated with a set of parameters. The set of parameters may include time domain parameters, frequency domain parameters, antenna domain parameters, or any combination thereof. The UE 115-a may receive a control message 210 indicating one or more states corresponding to the BWP, and each state may correspond to a subset of parameter values associated with the parameters indicated in the capability message 205. In such cases, the UE 115-a may receive a DCI message 215 based on the capability message 205 that indicates a state of the BWP. In this way, the UE 115-a may switch to the indicated state of the BWP and perform wireless communications via the BWP using the subset of parameter values associated the indicated state of the BWP.

In some examples of flexible light adaptation, the UE 115-a may report a capability to support different cases of light adaptation in the capability message 205. For instance, a bit map may be used to indicate the different cases of light adaptation, where each codepoint of the bitmap corresponds to a candidate set of parameters of a plurality of candidate sets of parameters. For example, 3 bits may be used to indicate different combinations of time, frequency, and antenna domain light adaptations. In some examples of such a 3 bit bitmap, 000 may indicate that the UE 115-a does not support any type of light adaptation. 111 may indicate that the UE 115-a supports all types of light adaptation (e.g., light adaptation in the time domain, frequency domain, and antenna domain). 100 may indicate that the UE 115-a supports time domain light adaptation. 010 may indicate that the UE 115-a supports frequency domain light adaptation. 001 may indicate that the UE 115-a supports antenna domain light adaptation. 110 may indicate that the UE 115-a supports time domain and frequency domain light adaptation. 011 may indicate that the UE 115-a supports frequency domain and antenna domain light adaptation. 101 may indicate that the UE 115-a supports time domain and antenna domain light adaptation. Other bitmaps (e.g., with more granularity and more bits in each codepoint, or less granularity with less bits in each codepoint), may also be utilized.

In some examples, additional detailed capability may be indicated with additional bits. For example, the addition of bits 11 may indicate the UE 115-a supports both a 4 to 1 antenna switching and 4 to 2 antenna switching, while the addition of bits 10 may indicate that the UE 115-a supports 4 to 1 antenna switching. Or, in some examples, the addition of bits 01 may indicate that the UE 115-a supports 4 to 2 antenna switching.

Such capability reporting may be associated with a set of parameters. The UE 115-a may receive a control message 210 indicating one or more states corresponding to the BWP, and each state may correspond to a subset of parameter values associated with the parameters indicated in the capability message 205. In such cases, the UE 115-a may receive a DCI message 215 based on the capability message 205 that indicates a state of the BWP. In this way, the UE 115-a may switch to the indicated state of the BWP and perform wireless communications via the BWP using the subset of parameter values associated the indicated state of the BWP.

In some examples of flexible light adaptation, each state in the light adaptation may include different light adaptation features. Additionally, or alternatively, each state in the light adaptation may include the same light adaptation feature but with different parameters or parameter values of the feature. For example, the UE 115-a may support a state (e.g., a fallback state) that may be configured as a low power mode state. In some cases, the network entity 105-a may configure the fallback state and, in some scenarios, expect the UE 115-a to switch to the fallback state. In some examples, the low power mode state (e.g., fallback state) may be configured with parameters corresponding to parameter values related to a small quantity of receiving antenna, a large threshold time offset (e.g., K0), a small bandwidth, or other parameters. There may be cases in which the UE 115-a supports a single component carrier (e.g., for power saving) while in the fallback state.

In some examples, the UE 115-a may indicate a set of parameters associated with a low power mode state (e.g., fallback state) in the capability message 205 or some other message. The UE 115-a may receive a control message 210 indicating one or more states corresponding to the BWP, and each state may correspond to a subset of parameter values associated with the parameters indicated in the capability message 205. The low power mode state may correspond to one of the states indicated in the control message 210. In some cases, the UE 115-a may receive a DCI message 215 based on the capability message 205 that indicates the low power mode state of the BWP. The UE 115-a may switch to the indicated low power mode state of the BWP and perform wireless communications via the BWP using the subset of parameter values associated the indicated low power mode state of the BWP.

In some examples, the configuration of the light adaptation state may be semi-static. For example, the UE 115-a may report capability information corresponding to each state (e.g., such as in the capability message 205, multiple capability messages, or another message). Additionally, or alternatively, the UE 115-a may send assistance information to the network entity 105-a for each state. In some cases, a first portion of the set of parameters in capability message 20-5 may correspond to the first state of the BWP, and a second portion of the set of parameters may correspond to the second state of the BWP. In some examples, the assistance information may include UE power saving assistance data (e.g., for the UE 115-a). The UE 115-a may receive the control message 210 indicating one or more states corresponding to the BWP, and each state may correspond to a subset of parameter values associated with parameters indicated in the capability information corresponding to each state, the assistance information for each state, or both. In such cases, the UE 115-a may receive a DCI message 215 based on the capability information for each state, the assistance information for each state, or both that indicates a state of the BWP. In this way, the UE 115-a may switch to the indicated state of the BWP and perform wireless communications via the BWP using the subset of parameter values associated the indicated state of the BWP.

In some cases of flexible light adaptation, the UE 115-a may dynamically indicate the type of light adaptation supported by the UE 115-a. For example, the UE 115-a may transmit a message indicating the type of light adaptation supported by the UE 115-a. In some cases, the message may be via uplink control information (UCI) or MAC-CE. The UE 115-a may receive a control message 210 indicate one or more states corresponding to the BWP based at least in part on the message indicating the type of light adaptation supported by the UE 115-a. In some examples, the UE may receive a DCI message 215 that indicates a state of the BWP based on the indication of the type of light adaptation supported by the UE 115-a. The UE 115-a may switch to the indicated state and perform wireless communications in accordance with a subset of parameter values associated with the indicated state of the BWP.

In some cases of flexible light adaptation, the UE category may indicate the type of light adaptation supported by the UE 115-a. The UE 115-a may receive a message (e.g., control message 210) indicating one or more states of the BWP based on the UE category. In some cases, the UE 115-a may receive a DCI message 215 that indicates a state of the BWP based on the message, and the UE may switch to the indicated state of the BWP and perform wireless communications via the BWP using parameter values associated with the indicated state of the BWP.

In some cases of flexible light adaptation, a trigger may result in a light adaptation at the UE 115-a. For example, the UE 115-a may autonomously trigger some types of light adaptation based on an event. For example, a receiving antenna adaptation feature could be switched or turned off (e.g., by SNR, reference signal received power (RSRP), UE mobility, data traffic, or other conditions or signals.). In some cases, the triggered light adaptation may include multiple types of light adaptation (e.g., time domain, frequency domain, antenna domain adaptation, or a more granular level of adaptation). In some examples, the UE 115-a may transmit a message indicating the type of light adaptation scheme in use at the UE 115-a. Alternatively, in some cases the UE 115-a may not transmit a message indicating the type of light adaptation scheme in use at the UE 115-a.

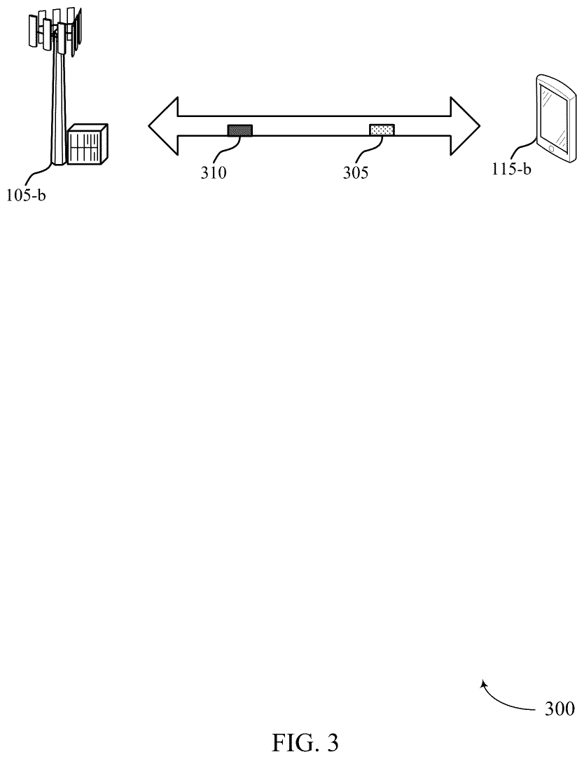

FIG. 3 shows an example of a wireless communication system 300 that supports UE capabilities and light adaptations in accordance with one or more aspects of the present disclosure. The wireless communications system 300 may implement, or be implemented by, aspects of the wireless communications system 100 and the wireless communications system 200. For example, the UE 115-b and the network entity 105-b may be examples of corresponding devices described with reference to FIG. 1 and FIG. 2.

In some implementations of light adaptation, the UE may receive utilize, or report, or otherwise be configured according to, restrictions associated with the indicated state of a BWP configuration, or the states may be based on or may accommodate one or more restrictions. Such scheduling restrictions (and associated state or states) may enable the UE to avoid large reconfigurations and the reprogramming of registers. For example, in one state a UE may keep a maximum rank of 4 with scheduling restriction such that the network entity may refrain from scheduling with rank 4 for a period of time. The UE may save power during the time slots of the indicated scheduling restriction based on the state with the scheduling restrictions. As another example, in one state a UE may maintain an active BWP of 100 MHz with a scheduling restriction such that the network entity may refrain from scheduling beyond 20 MHz. In such examples, the UE may save power associated with frequency resources. Thus, the UE may refrain from reconfiguring or reprograming the UE registers to support light adaptation, such as light adaptation with scheduling restrictions associated with one or more states.

Use of scheduling restrictions in light adaptation may result in power savings at the UE, reduced switching timelines, and reduced consequences for OOS. In some examples, energy reduction may be achieved with light adaptation compared to an all narrow band or all wide band baseline. In some implementations, by removing the need for the UE to reconfigure or reprogram registers, light adaptation may reduce the time the UE utilizes to transition between states. In some examples, the switching timeline may be based on the duration of a radio frequency retune, or a baseband retune. As one example, the amount of time needed for a radio frequency retune as part of a light adaptation may be smaller than the amount of time needed for a UE to reprogram the UE registers to support a full adaptation with similar changes. Such a reduced switching timeline may enable the network entity to switch states at the UE (e.g., to a power saving state) more frequently. In some examples, the UE 115-b may report one or more scheduling restrictions or supported scheduling restrictions (e.g., via capability information). In some examples, the network entity 105-b may configure the UE 115-b with multiple states (e.g., state 0 and state 1). One of the states may correspond to a scheduling restriction (e.g., in the frequency domain, in the time domain, in the antenna domain, or any combination thereof), and the other state may correspond to no restrictions (e.g., or different restrictions). Thus, in a first state (e.g., state 0), the network may refrain from scheduling communications via the frequency resources or time resources, or both, that are restricted according to the first state, saving power or other resources at the UE 115-a.

In some examples, the UE 115-b may receive a control message 305 indicating two or more states. For example, the control message 305 may indicate at least a first state of two or more state corresponding to BWP and a second state of the two or more states corresponding to the BWP, and each state may be associated with a set of parameter values. The UE 115-b may communicate with a network entity 105-b according to the first state or the second state with the corresponding parameter value in a RRC connected mode. The UE 115-b may receive a RRC connection release message 310 with an indication of the first state. When the UE 115-b reconnects with the network entity 105-b, the UE 115-b may do so according to the first state indicated in the RRC connection release message 310. As such, the UE 115-b may communicate according to the first state indicated in the RRC connection release message 310 in accordance with the reconnecting. Thus, in accordance with the indication in the RRC connection release message 310, the UE 115-b may determine which state to utilize to when performing the reconnection.

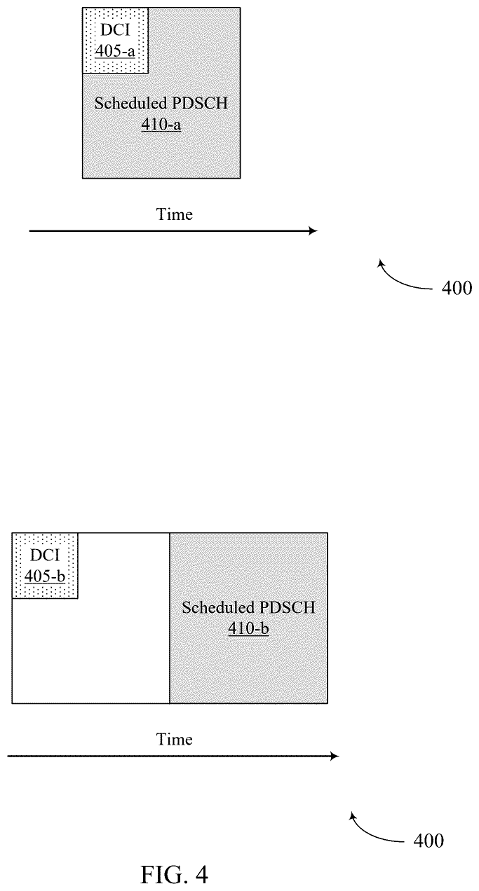

FIG. 4 shows example of a timelines 400 and 401 that supports UE capabilities and light adaptations in accordance with one or more aspects of the present disclosure. The timelines 400 and 401 may implement, or be implemented, by aspects of the wireless communications system 100, the wireless communications system 200, or the wireless communications system 300. For example, a network entity and a UE (e.g., which may be examples of corresponding devices described with reference to FIGS. 1-3) may communicate in accordance with the timelines 400 and 401.

As described herein, the UE may support light adaptation. In some examples, the UE may support a quantity of antennas (e.g., which may correspond to a quantity of configured layers). In some examples, the UE may be scheduled to perform uplink transmissions (e.g., via a physical uplink shared channel (PUSCH)) or downlink transmissions (e.g., via a physical downlink shared channel (PDSCH). For example, the DCI 405-a may schedule the PDSCH 410-a in the same slot as the DCI 405-a is received, or the DCI 405-b may schedule the PDSCH 410-b in a subsequent (e.g., next) slot. A time offset may define an offset between reception of the scheduling DCI 405 and the scheduled signaling or other wireless signaling. In some examples, the scheduling offset may be described in terms of K0, K1, K2, N1, N2, or any combination thereof. In such example, K0 may correspond to a scheduling offset for PDSCH, K1 may correspond to a scheduling offset for feedback signaling (e.g., acknowledgement (ACK) or negative acknowledgement (NACK) signaling), K2 may correspond to a scheduling offset for PUSCH, N1 may correspond to a scheduling offset related to UE processing capability of PDSCH (e.g., the time the UE may need to modulate or generate a bit stream), and N2 may correspond to a scheduling offset related to the UE preparation time of the PUSCH (e.g., the time between a trigger to send data and when the data is actually sent).

In some examples, the DCI may indicate a number of layers to be used. For example, the DCI 405-a may schedule the PDSCH 410-a with an offset value of 0 (e.g., K0=0), for a number of layers=1. If the UE is configured with a threshold quantity of layers or antennas equal to 2, then the UE may be able to easily utilize a single layer for reception during the same slot. The DCI 405-b may schedule the PDSCH 410-b in a subsequent slot (e.g., K0=1) with a quantity of layers of 4. If the UE is using only 2 antennas in the first slot, then it may take some time to activate the two additional antennas and receive via the PDSCH 410-b (e.g., which the UE may be able to do with a K0=1). However, if the PDSCH 410-a were scheduled to be received via 4 layers (e.g., 4 antennas), and the UE had deactivated 2 antennas, then the UE may not be able to activate the 2 additional antennas within the same scheduling slot to receive the PDSCH 410-a.

Light adaptation may include a quantity of layers that the UE is going configured to use. For instance, instead of configuring or reconfiguring a threshold quantity of layers (e.g., a maximum rank parameter), the network entity may switch the UE between states. For instance, the UE may support 4 antennas (e.g., N active antennas). The network may also indicate that the UE will not be configured to use any more than a subset of the M active antennas (e.g., the UE will not be scheduled with more than N of the M active antennas). In some examples, a state may support scheduling restrictions, in which case only N out of M active antennas may be scheduled (e.g., via a DCI). In some cases (e.g., a first state), the UE may be configured to utilize no more than the total quantity of 4 active antennas. In some cases (e.g., a second state), the UE may be configured to utilize no more than 2 antennas out of the 4 active antennas. In some cases (e.g., the second state or a third state), the UE may be configured to utilize no more than 1 antenna out of the 4 active antennas.

If the UE is in a state with scheduling restrictions, or if the UE is configured to use no more than N out of M antennas, then the UE may determine what to do with the additional active (e.g., but unscheduled) antennas (e.g., the M-N active antennas). For example, in a first state (e.g., state A), the UE may turn the M-N antennas off, radio frequency, receive and transmit chains, and baseband may all be turned off. Such a scenario may increase power savings because the radio frequency chains are off, and the baseband being off allows more power savings. However, if the UE has turned off the additional antennas (which may include corresponding components or subcomponents). in state A, then the UE may no longer support small scheduling offsets (e.g., K-0=0). For example, the UE may rely on a larger K0 value if additional unused antennas are turned all the way off. In some examples, in another state (e.g., state B), the UE may maintain the M-N antennas in a transient or on state (e.g., the M-N antennas are not scheduled, but are still active). State B may correspond to a baseband power state that matches the N antennas (e.g., instead of a higher power state corresponding to the M antennas). Such a scenario may not take advantage of power savings, but may instead prioritize latency. For example, such antennas may be available for small scheduling offsets (e.g., K0=0). For instance, if the UE is in state A, and the DCI 405-a schedules the PDSCH 410-a with all four antennas (e.g., and the UE is in state A with two antennas inactive), then the UE may not be able to active at the additional antennas in time for the scheduled PDSCH 410-a. However, if the UE prefers to conserve power, it may benefit from larger scheduling offset values and state B. States A and B may refer to internet settings at the UE (e.g., and may not be the same as light adaptation states).

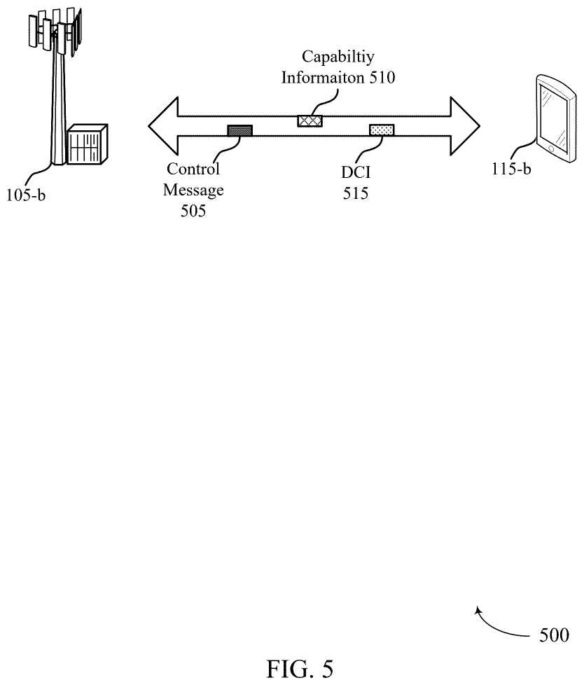

As described herein (e.g., in greater detail with reference to FIG. 5), the UE may report its capabilities (e.g., corresponding to a selection of either state A or state B, among other examples), and the network entity may select an applicable offset value (e.g., K0, K1, K2, N1, N2, or other timing offset.). If the M-N antennas are in state B, then the UE may need less time (e.g., a threshold or minimum K0>U) to bring up the antennas for scheduling. Alternatively, if the UEs N-M antennas are in state A, then the M-N antennas may need more time to bring up the antennas for scheduling (e.g., a threshold or minimum K0>V, where U<V).

For example, the UE may report a fast timeline (e.g., the timeline corresponding to U), or a slow timeline (e.g., the timeline corresponding to V). The fast or slow timelines may be indicated, by the UE, from one or more timeline defined in one or more standards or configured at the UE). The UE may indicate that it supports a fast timeline. In such examples, the UE may enter power state A (e.g., in a light adaptation state in which some scheduling restrictions apply). In such examples, the network entity may schedule the UE with small scheduling offsets (e.g., K0=0) because the UE has maintained additional (e.g., currently unused) antennas in an active state, and the UE may support scheduling of PDSCH 410-a. The UE may indicate that it supports a slow timeline. In such examples, the UE may enter a power state B (e.g., in a light adaptation state in which some scheduling restrictions, such as a N antennas, are applied). In such examples, the network entity may schedule communications with longer scheduling offsets (e.g., K0=1 or more), such that the UE has time to activate the M-N antennas (e.g., for the scheduled PDSCH 410-b). As described in greater detail with reference to FIG. 5, the reported capabilities may be more granular or less granular.

FIG. 5 shows an example of a wireless communications system 500 that supports UE capabilities and light adaptations in accordance with one or more aspects of the present disclosure. The wireless communications system 500 may implement, or be implemented by, aspects of the wireless communications system 100, the wireless communications system 200, the wireless communications system 300, the timeline 400, and the timeline 401. For example, the wireless communications system 500 may include a UE 115-b and a network entity 105-b (e.g., which may be examples of corresponding devices described herein). The UE 115-b and the network entity 105-b may the same or different devices from the UEs 115 and network entities 105 described herein.

The UE 115-b may transmit a capability information 510. The capability information 510 may indicate timing information, such as a fast timeline or a slow timeline (e.g., as described in greater detail with reference to FIG. 4).

The UE 115-b may receive a control message 505, which may include an indication of a BWP configuration, one or more states, or an indication of which state the UE 115-b is to enter with reference to light adaptation. For instance, the control message 505 may indicate that the UE 115-b is in a state in which a threshold quantity of antennas (e.g., N) of a total quantity of antennas activated at the UE 115-b (e.g., M) are to be scheduled while in a particular state.

The UE 115-b may receive a DCI message (e.g., the DCI 515). The DCI 515 may switch states for the UE (e.g., light adaptation), may schedule wireless communications, or both. For example, the DCI 515 may schedule a PDSCH in accordance with a scheduling offset (e.g., K0). The scheduling offset may be based on the capability information. For instance, if the UE 115-b indicates the slow switching timeline, then the network entity 105-b may refrain from scheduling wireless communications at a scheduling offset (e.g., K0, K1, N1) that is less than a threshold (e.g., K0=1). If the UE 115-b reports a fast switching timeline, then the network entity 105-b may schedule the UE 115-b in accordance with smaller scheduling offsets (e.g., K0=0, among other examples). In some examples, the UE 115-b may perform power saving operations (e.g., may put to sleep or deactivate a baseband or one or more of the M-N antennas) if the slow switching time is indicating in the capability information 510.

In some examples, the UE 115-b may report more granular capability information. For example, the UE 115-b may indicate support for various ranks, or antenna values in light adaptation. The capability information 510 may include sub-capabilities that indicate combined support for specific scheduling offsets (e.g., K0/K1/K2, N1/N2) for different assumptions or scenarios based on a threshold quantity of N active antennas of the at least one or more threshold M scheduled antennas for a scheduled transmission (e.g., PDSCH). For example, if UE 115-b is configured to be scheduled with no more than N out of M antennas, then the UE may indicate various sub-capabilities, such as the illustrative examples shown in Table 1:

TABLE 1

| | Early | | | | |
|---|---|---|---|---|---|
| | Indication | | | | |
| | of how | | | Threshold | |
| | many | | Threshold | Scheduling | |
| | antennas | | N of | Offset | |
| | are | M Active | scheduled | (K1/K1) | |
| Sub-capabilities | scheduled | antennas | antennas | (or N1) | UE Action |
| 1: Default Capability | No | 4 | N/A | 0/(1 or 2) | BB clock set to |
| | | | | | sustain peak |
| | | | | | throughput |
| 2: Latency Prioritized | Yes (e.g., | 4 | 2 | 0/1 | Enter State B |
| | 2 out of 4) | | | | |
| 3: RF + BB | Yes (e.g., | 4 | 1 | 3/2 | Enter State A |
| Power Prioritized | 1 out of 4) | | | | |
| 4: BB Power/latency | Yes (e.g., | 4 | 2 | 0/1 | Match BB to N |
| Prioritized | 2 out of 4) | | | | antennas, put RF to |
| | | | | | lower power state |
| | | | | | on M-N antennas |
| | | | | | after decoding DCI |
| 5: Reduced capability | Yes | 4 | 2 | 0/3 | Set BB clock as if |
| mode | | | | | using 1 antenna, |
| | | | | | collect samples |
| | | | | | from N antennas, |
| | | | | | relax feedback |
| | | | | | timing. |

In accordance with table 1, the UE 115-b may report one or more sub-capabilities. The UE may be configured (e.g., in a particular state via light adaptation) with an early indication of how many antennas are scheduled. For instance, if the UE 115-b prioritizes latency, then the UE 115-b may report the sub-capability 1, the sub-capability 2, and the sub-capability 4. In such examples, the network entity 105-b may schedule communications (e.g., via the DCI 515) having scheduling offset (e.g., K0 or K1) equal to 0 or 1. However, if the UE 115-b changes priorities (e.g., due to low battery or other scenarios), then the UE 115-b may report different sub-capabilities (e.g., such as the sub-capability 3 or the sub-capability 5) in which case the network entity 105-b may schedule communications with longer scheduling offsets. The UE may autonomously take any of the actions described in Table 1 based on the sub-capabilities reported, the priorities of the UE 115-b, and the capabilities of the UE 115-b (e.g., some UEs may be able to activate M-N antennas faster than other UEs 115, which may impact actions taken, not conserve power or prioritize latency, or other outcomes.). Thus, by reporting a particular sub-capability, the UE 115-b may more effectively, and flexibly, prioritize latency, or power, and may take internal actions accordingly.

Depending on which stat the N-M antennas are in, when the UE 115-b is indicated which of the antenna ports are scheduled in the DCI 515, the UE 115-b may expect a corresponding scheduling offset. In some examples, the UE 115-b may support event based change of mode. In such examples, when the delay exceeds a configurable threshold, and is reported in a delay status report, the UE 115-b may automatically switch to a latency prioritized mode (e.g., to sub-capability 2 or sub-capability 4). Thus, in the case of delay sensitive traffic, the UE 115-b may switch to a high power mode. In some examples, when a beam status report (BSR) or logical channel priority exceeds a configurable threshold and is reported in the delay status report, the UE 115-b may automatically switch to a latency prioritized mode (e.g., such as sub-capability 2 or sub-capability 4). In such examples, the UE 115-b may switch to the high power mode if there is important or high priority traffic pending, or in the case of a high volume of traffic. The network entity 105-b, or the UE 115-b, or both, may suggest dynamic updates to the initial configuration. Such requested or proposed updates may be conveyed via DCI, UCI, downlink MAC_CE, uplink MAC-CE, or as part of a UAI message.

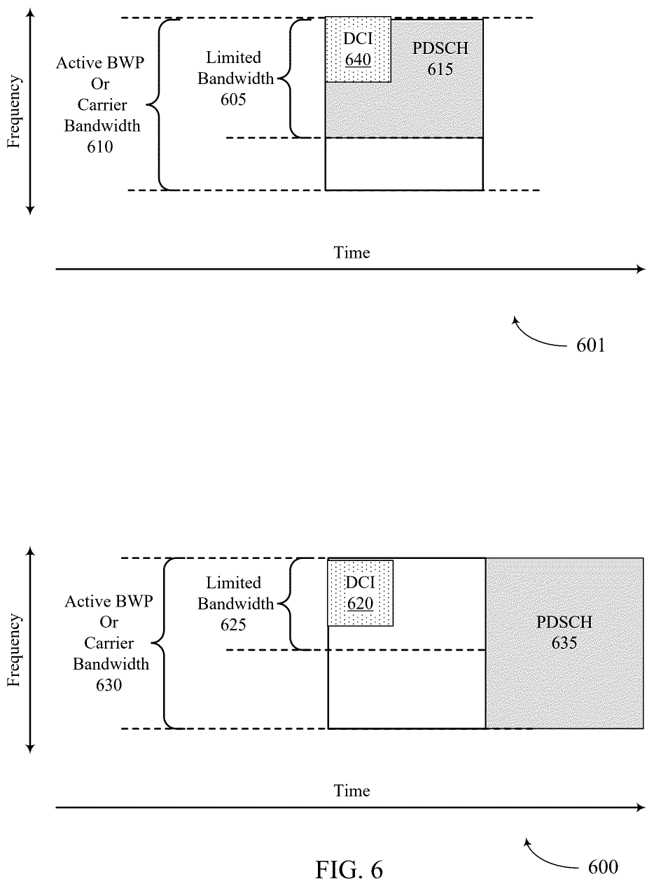

FIG. 6 shows an example of a timeline 700 and a timeline 601 that support UE capabilities and light adaptation in accordance with one or more aspects of the present disclosure. The timeline 600 and the timeline 601 may implement, or be implemented by, aspects of the wireless communications system 100, the wireless communications system 200, the wireless communications system 300, the timeline 400, the timeline 401, and wireless communications system 500. For example, a UE and a network entity (e.g., which may be examples of corresponding devices described herein) may communicate in accordance with the timeline 600 and the timeline 601.

In some examples, scheduling restrictions (e.g., in the time domain, frequency domain, or both) may be associated with a light adaptation. Such light adaptation may be associated with two or more states (e.g., a state with scheduling restrictions and a state without scheduling restrictions). Switching may be triggered by a DCI (e.g., that has the same size between the two or more states). The UE may support sufficient switching time (e.g., to transition from a low power state to a high power state). Such light adaptation, as described herein, may support updates to a small quantity of parameter values with every switch (e.g., reducing any reconfiguration). In some examples, the UE may switch from a first state to a second state, where the first state is a low power state and the second state is a high power state. In some examples, the switching timeline may include sufficient time to transition from the low power state to the high power state. In light adaptation, the quantity of parameter values re-written with each switch may be low, such that the switching times between states may be lower than adaptations in which the UE to reconfigure or reprogram all or large portions of registers.

For example, the UE may receive a control message with an indication of a first state of a BWP (e.g. corresponding to the timeline 601) with one or more scheduling restrictions, and an indication of a second state of the BWP (e.g., without scheduling restrictions). The UE may receive a DCI message indicating the first state or the second state. In some examples, the UE may report one or more capabilities corresponding to scheduling restrictions.

For example, in some examples (e.g., in a first state), the UE may support a limited bandwidth 605 (e.g., 20 MHz or another bandwidth) of an active BWP or carrier bandwidth 610. If the UE does not have sufficient time, the UE may not be able to adjust one or more parameters to receive signaling via a wider bandwidth (e.g., the active WP or carrier bandwidth 610). For instance, in a first state the UE may be limited to the limited bandwidth 605, and in a second state the UE may be configured to communicate via the full active BWP or carrier bandwidth 630.

In some cases, as illustrated by the timeline 601, scheduling restrictions may apply, such that the UE may be ready to receive downlink messages within the limited bandwidth 605, and may not be ready to receive downlink messages outside of the limited bandwidth 605 (e.g., without enough time to adjust one or more parameters or retune to the wider channel). The DCI 640 may indicate the scheduling offset (e.g., K0=0) and may conform to the scheduling restrictions based on the timing offset (e.g., messages may be scheduled within limited bandwidth 605, and not outside of it in accordance with the scheduling restriction). As such, the network entity may schedule PDSCH 615 during the same slot the DCI 640 was received (e.g., K0=0), but only using the frequency resources within the limited bandwidth 605 (e.g., scheduling restrictions). The first state may be an example of a low power state, where the UE may save power by refraining from using the frequency resource outside of the limited bandwidth 605 according to the scheduling restrictions.

In some examples, as illustrated by the timeline 600, the scheduling limitation may not apply if there is sufficient time for the UE to adjust one or more parameters for communications via the active BWP or carrier bandwidth 630. For example, the DCI 620 may indicate a K0=1, in which case the scheduling limitation may not apply. In such examples, the UE may receive the DCI 620 in a first slot and be available to schedule PDSCH 635 in the next slot using frequency resources within the active BWP or carrier bandwidth 630 (e.g., 100 MHz), instead of only in the limited bandwidth 625.

The second state may be an example of a high power state, where the UE may keep frequency resources available for scheduling messages (e.g., PDSCH 635) outside of the limited bandwidth 625 according to the scheduling restrictions or lack of scheduling restrictions.

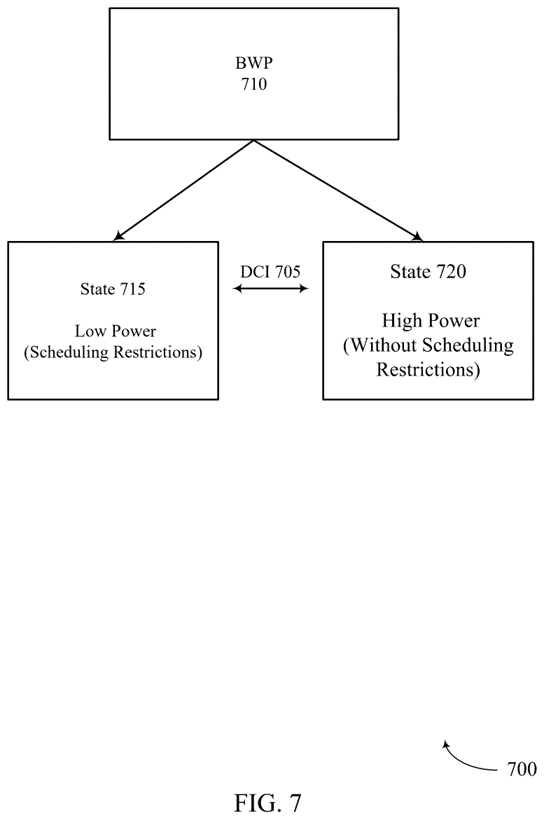

As described in greater detail with reference to FIG. 7, within the active BWP, the UE may support multiple states (e.g., a low power state and a high power state). The low power state may be associated with the limited bandwidth and therefore scheduling restrictions (e.g., to utilize the full bandwidth, the UE may rely on longer scheduling offsets). The high power state may support wider bandwidths (e.g., without any scheduling restrictions). A DCI message may switch the UE between states, and the UE may report one or more capabilities regarding the restriction requirements, as described in greater detail with reference to FIG. 7.

FIG. 7 shows an example of a state switching scheme 700 that supports UE capabilities and light adaptations in accordance with one or more aspects of the present disclosure. The state switching scheme 700 may implement, or be implemented by, aspects of the wireless communications system 100, the wireless communications system 200, the wireless communications system 300, the timeline 400, the timeline 401, the wireless communications system 500, the timeline 600, and the timeline 601. For example, a UE and a network entity (e.g., which may be examples of corresponding devices described with reference to FIG. 1-6) may communicate in accordance with the state switching scheme 700.

Within an active BWP 710, there may be one or more states (e.g., sub-configurations), such as a state 715 and a state 720. For example, the UE may transmit a capability message indicating a set of parameters for which the UE supports changing parameter values when switching between states (e.g., state 715 and state 720). The UE may receive a control message indicating the state 715 and the state 720, where the state 715 corresponds to a first subset of one or more parameter values (e.g., of the set of indicated parameters), and the state 720 corresponds to a second subset of one or more parameter values (e.g., of the set of indicated parameters).

In some examples, the UE may receive a DCI 705, which may indicate the state 715 or the state 720 to the UE. As such, the UE may perform wireless communications via the BWP using the subset of parameter values associated with the state indicated in the DCI 705. For example, the state 715 may be a low power state within the BWP with a limited bandwidth (e.g., 20 MHz) and scheduling restrictions. The UE may receive the DCI 705 indicating the state 715 and the UE may perform wireless communications in a low power state with a limited bandwidth and scheduling restrictions, according to the parameter values associated with the state 715.

In some examples, the state 720 may be a high power state within the BWP with a wider bandwidth than state 715 and without scheduling restrictions, or without the same scheduling restrictions as those in the state 715. The UE may receive the DCI 705 indicating the state 720 and the UE may perform wireless communications in a low power state with a limited bandwidth and scheduling restrictions according to the parameter values associated with the state 720.

In some cases, the UE may support dynamic switching between states, semi-static switching between states, or both. For example, the UE may indicate (e.g., via capability information) whether the UE supports dynamic switching, semi-static switching, or both between the state 715 and the state 720 in the capability message. In cases where the UE supports dynamic switching, the UE may receive DCI (such as the DCI 705) indicating for the UE to switch from the state 715 to the state 720 (or vice versa) within the BWP. In cases where the UE supports semi-static switching, the UE may receive control signaling (e.g., RRC signaling or a trigger message), based on which the UE may switch between states, or the UE may be preconfigured with conditions such that when a condition is satisfied (e.g., such as a satisfied threshold), the UE may switch from the state 715 to the state 720 (or vice versa) within the BWP. The state 715 may not be associated with scheduling restrictions, while the state 720 may support scheduling restrictions in the time domain, the frequency domain, or both. Thus, the capability message may include an indication of the type of scheduling restrictions supported at the UE.

In some cases, the type of supported scheduling restriction (e.g., time domain, frequency domain, or both) may be dependent on a type of slot (e.g., a respective slot type). In such cases, the capability message may include an indication of the type of scheduling restriction(s) supported at the UE and include the type of slot for which the scheduling restrictions are supported. For example, the UE may support scheduling restrictions in the time domain, the frequency domain, or both on one type of slot (e.g., downlink slots, uplink slots, or other slot types). In other examples, the UE may support scheduling restrictions in the time domain, the frequency domain, or both on any combination of slots. That is, the UE may support scheduling restrictions on more than one type of slot, resulting in a combination of slot types on which the UE supports scheduling restrictions. Additionally, or alternatively, the UE may support scheduling restrictions based on RRC configured types of slots.

In some examples, the UE may be capable of switching between more than two states. For example, the UE may support the state 715 with no scheduling restrictions and a fast switching timeline (T1), the state 720 with scheduling restrictions and T1, and a third state with a second switching timeline (T2). The third state may be associated with a third (e.g., different) subset of parameter values corresponding the set of parameters indicated in the capability message. It is possible that the third subset of parameter values may be associated with different parameters or more parameters than the subsets of parameter values corresponding the state 715 and the state 720. As such, UE may store a greater quantity of parameter values in the UE memory as part of switching to the third state, which may affect T2 such that T2 may be longer than T1. The UE may report, via capability information, how many states (e.g., a quantity of states), or which states (e.g., from a set of candidates states) the UE supports.

In some cases, the UE may support scheduling restrictions in the time domain. For example, the state 715 may be associated with scheduling restrictions that limit communications to certain slots or a certain periodicity of slots (e.g., every four slots). Alternatively, the state 720 may not have scheduling restrictions or allow communications for every slot. In such an example, the state 715 may be a low power state and the state 720 may be a high power state.

In some cases, the UE may indicate the ability to support more than two states corresponding to the BWP in the capability message. In some examples, the capability message may include an indication of a quantity of states corresponding to the BWP among which the UE supports switching. Additionally, or alternatively, the UE may include an indication of a threshold timing corresponding to switching among the quantity of states. For example, the UE may indicate a threshold timing for switching between states in the capability message. In turn, the UE may receive a control message indicating the state 715, the state 720, and a third state, where the switching timelines associated with each state is below the indicated threshold timing.

In some examples, the UE may support more than one type of handling configuration. For example, the capability message may indicate one or more parameters that the UE supports for multiple states corresponding to the BWP. For the case of differential configurations (e.g., SRS configurations for codebook/noncodebook are different between the two or more states) one common configuration may not be realized. For example, in some cases, the state 715 may be associated with a first configuration and the state 720 may be associated with a second configuration, where the first configuration and the second configuration are different. In such case, the UE may indicate the capability to support the state 715 and the state 720 with their separate configurations via a capability message (the capability message or another capability message). Additionally, or alternatively, in such cases the UE may indicate a capability to support multiple states of the BWP with different configurations (e.g., more generally, and without reference to any single state).

However, in some cases, a configuration may be common between the two or more states. For example, in some cases, a common configuration (e.g., a shared configuration, a duplicate configuration, or other configuration scenario) may exist for the state 715 and the state 720. In some cases of a common configuration, the state 715 and the state 720 may be differentiated by scheduling restrictions. In some cases, the UE may indicate the capability to support the state 715 and the state 720 with a common configuration via a capability message (the capability message or another capability message). Additionally, or alternatively, in such cases the UE may indicate a capability to support multiple states of the BWP with a common configuration (e.g., more generally, and without reference to any single state).

In some examples of light adaptation, scheduling restrictions applied to downlink communications may also be applied to uplink communications (e.g., as indicated via an implicit or explicit indication). For example, the UE may indicate one or more scheduling restrictions supported by or relied on by the UE for downlink signaling, and (e.g., explicitly or implicitly) the report may indicate whether the same restrictions are supported for uplink signaling, for the same band, state, or BWP, or for other bands, or a combination thereof, among other examples. Additionally, or alternatively, scheduling restrictions for downlink communications, and scheduling restrictions for uplink communications may be separately indicated per band, or per state within the BWP. For example, the control message may indicate whether one or more scheduling thresholds apply to downlink communications, uplink communications, communications per band, for a same or other BWP, or any combination thereof, among other examples.

In some examples, the control message may include an indication of scheduling restrictions per signal or channel. As such, some channels or signals may be excluded from scheduling restrictions. For example, the UE may still receive SSBs during the gaps even if there is a scheduling restriction in the gap (e.g., according to some reported capabilities or configured states).

In some examples, scheduling restrictions may result in an active state that is a subset of a high power state. For example, the UE may receive an indication of scheduling restrictions and a first state of the BWP, where the first state of the BWP is an active state and is related to a second state that is a high power state. For example, in some cases, the first state may be associated with a bandwidth (e.g. BW1), and the high power state may be associated with a second bandwidth (BW2). In such cases, BW1 may be less than BW2 and the frequency location of BW1 may be a subset of the frequencies of BW2. In another example, the number of antennas associated with the first state may be less than the number of antennas associated with the second state (e.g., high power state), then the active antennas in the first state may be a subset of the active antennas in the second state. In some cases, one or more rules or reported capabilities may indicate the one states is a subset of the other state.

In some cases, the capability message may include an indication of one or more scheduling restrictions based on respective slot types (e.g., slots associated with the same resources as resources associated with the scheduling restrictions). Additionally, or alternatively, the capability message may include an indication of a signaling type for which the UE supports switching among two or more states corresponding to the BWP while satisfying one or more scheduling restrictions. In some cases, the indicated signaling type may be used to introduce the two or more states to the UE, indicate for the UE to switch states, introduce scheduling restrictions to the UE, or any combination thereof. The indication of the signaling type may be associated with one signaling type or multiple signaling types. For example, in some cases the UE may only support one type of signaling, such as signaling based on uplink and/or downlink scheduling DCI, non-scheduling DCI, Group Common DCI (GC-DCI), MAC-CE, or any combination thereof. In some cases, the UE may support one or more types of signaling, such as signaling based on uplink and/or downlink scheduling DCI, DCI that schedule data, non-scheduling DCI (or DCI that do not schedule data), group common DCI (GC-DCI), MAC-CE, or any combination thereof.

In some cases, the scheduling restrictions may be associated with whether the UE is in an RRC active, RRC idle, or RRC inactive state. In some examples, the UE may receive a control message indicating two or more states, such as the state 715 of the BWP and the state 720 of the BWP, where the state 715 corresponds to a first subset of one or more parameter values, and the state 720 corresponds to a second subset of one or more parameter values. The UE may communicate according to the state 715 and the corresponding first subset of one or more parameter values in a RRC connected mode. The UE may receive a RRC connection release message indicating a first state of two or more states (e.g., state 715 or state 720). Accordingly, the UE may reconnect to a network entity according to the first state indicated in the connection release message. As such, the UE may communicate according to the first state (e.g., and the subset of parameter values corresponding to the first state) as indicated in the connection release message according to the reconnection.

As one example, the UE may operate according to the parameter values associated with the state 715 of the BWP, receive a RRC release message, such as when there is not activity for a certain amount of time, and enter a low-power state. The RRC release message may include an indication of the state 720 such that the UE may reconnect to the network entity (e.g. resume RRC connected mode) and operate according to the parameter values associated with the state 720.

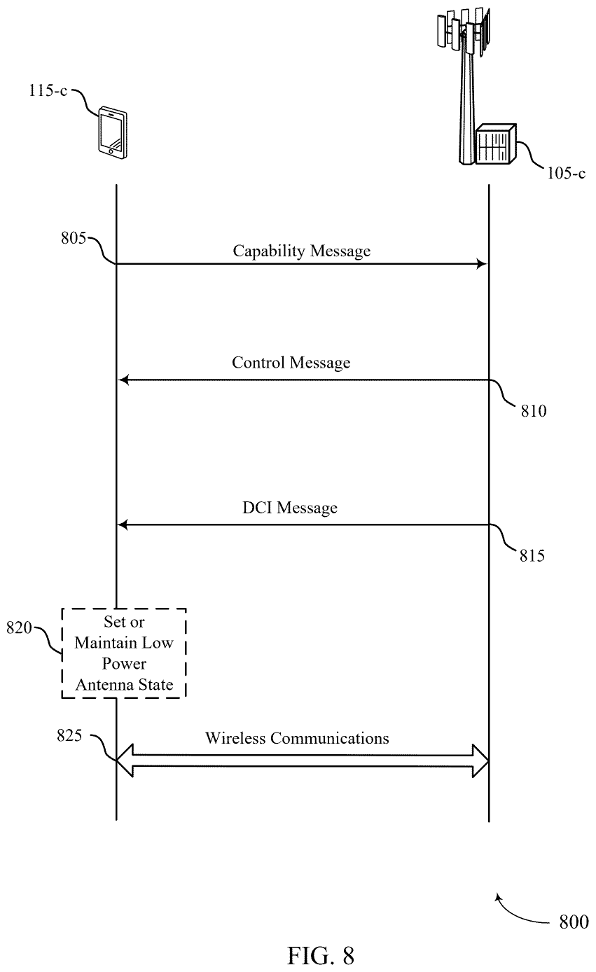

FIG. 8 shows an example of a process flow 800 that supports UE capabilities and light adaptations in accordance with one or more aspects of the present disclosure. Aspects of the process flow 800 may implement, or be implemented to realize, aspects of the wireless communications system 100, the wireless communications system 200, the wireless communications system 300, the timeline 400, the timeline 401, the wireless communications system 500, the timeline 600, the timeline 601, and the state switching scheme 700. For example, the process flow 800 may include a UE 115-c (e.g., which may be an example of a UE, a UE 115, the UE 115-a, the UE 115-b, or other corresponding devices) and a network entity 105-c (e.g., a network entity, the network entity 105-a, the network entity 105-b, or other corresponding devices).

In the following description of the process flow 800, the operations between the devices may occur in a different order than the example order shown and, in some examples, may be performed by one or more different devices other than those shown as examples. Some operations also may be omitted from the process flow 800, and other operations may be added to the process flow 800. Further, although some operations or signaling may be shown to occur at different times for discussion purposes, these operations may actually occur at the same time. The techniques described in the context of the process flow 800 may enable the UE 115-c to signal capabilities and perform a light adaptation such that the UE 115-c may switch between two or more states of a BWP, where a DCI message indicating the state of the BWP maintains a consistent size despite the state of the BWP that the DCI message indicates.

At 805, the UE 115-c may transmit a capability message including an indication of timing information corresponding to an antenna switching procedure (e.g., a fast switching timeline, a slow switching timeline, a set of sub-capabilities, other timing-related information).

At 810, the UE 115-c may receive a control message indicating at least a first state corresponding to a BWP and a second state corresponding to the BWP, wherein the first state corresponds to a first quantity of antennas, and the second state corresponds to a second quantity of antennas.

At 815, the UE 115-c may receive a DCI message indicating the first state of the BWP based on the capability message. Additionally, or alternatively, the DCI message may schedule wireless signaling.

At 820, the UE 115-c may set or maintain a low power antenna state. In some examples, the UE 115-c may apply the parameter values corresponding to the first state as indicated in the DCI message. In some examples, the UE 115-c may take actions such as putting one or more antennas in a low power state, or maintaining antennas in an active state, or changing a baseband power setting.

At 825, the UE 115-c may perform wireless communications via the BWP and at least the first quantity of antennas based at least in part on the DCI message, wherein a timing of the wireless communications is according to the indication of timing information. For example, the network entity 105-c may refrain from scheduling the UE 115-c with a scheduling offset smaller than a threshold if a slow timeline or power conserving sub-capabilities are reported at 805. Or, the network entity 105-c may schedule the UE 115-c with smaller scheduling offsets (e.g., K0=1 or K0=0, among other examples) if the UE 115-c reports a faster switching timeline or latency prioritizing sub-capabilities at 805.

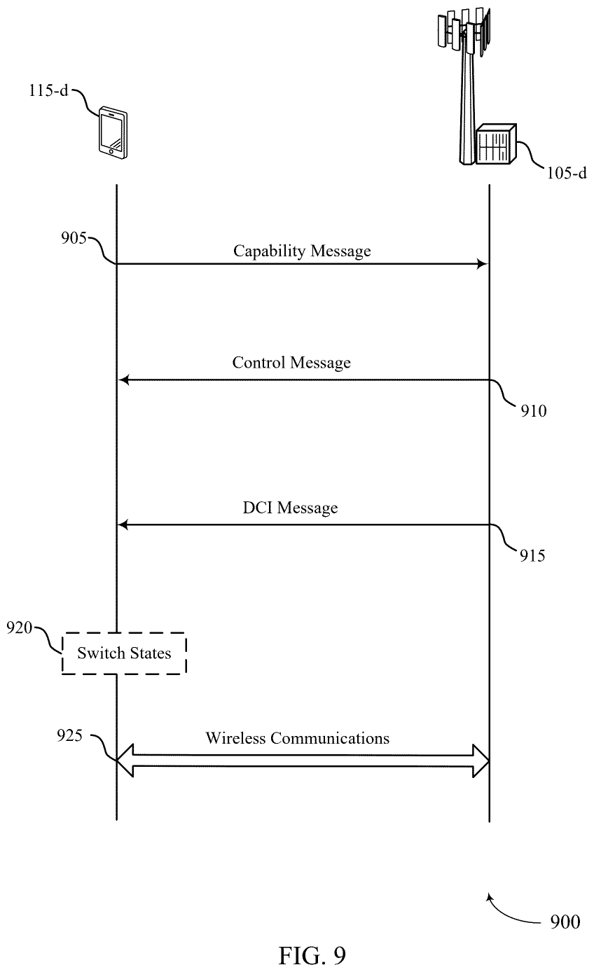

FIG. 9 shows an example of a process flow 900 that supports UE capabilities and light adaptations in accordance with one or more aspects of the present disclosure. Aspects of the process flow 900 may implement, or be implemented to realize, aspects of the wireless communications system 100, the wireless communications system 200, the wireless communications system 300, the timeline 400, the timeline 401, the wireless communications system 500, the timeline 600, the timeline 601, the state switching scheme 700, and the process flow 800. For example, the process flow 900 may include a UE 115-d (e.g., a UE, a UE 115, a UE 115-a, a UE 115-b, a UE-115-c, or other corresponding devices) and a network entity 105-d (e.g., a network entity, a network entity 105-a, a network entity 105-b, a network entity 105-c, or other corresponding devices).

At 905, the UE 115-d may transmit a capability message (e.g., capability message 205) indicating a set of parameters for which the UE 115-d supports switching between one or more states of a BWP. In such examples, the set of parameters may comprise time domain parameters, frequency domain parameters, antenna domain parameters, or any combination thereof. In some examples, the capability message may include a bitmap where each codepoint of the bitmap corresponds to a candidate set of parameters out of a plurality of candidate sets of parameters.

In some cases, a first portion of the set of parameters may correspond to the first state, and a second portion of the set of parameters may correspond to the second state. In such examples, the UE 115-d may report a capability per state of the BWP.

At 910, the UE 115-d may receive a control message (e.g., control message 210) indicating at least a first state corresponding to the BWP and a second state corresponding to the BWP, based at least in part on the capability message transmitted at 905. The first state may correspond to a first subset of one or more parameter values of the set of parameters, and the second state may correspond to a second subset of one or more parameter values.

At 915, the UE 115-d may receive a DCI message (e.g., DCI message 215) indicating the first state of the BWP.

At 920, the UE 115-d may switch to the first state of the BWP.

At 925, the UE 115-d may perform wireless communications via the BWP and using the first subset of parameters values based at least in part on the DCI message.

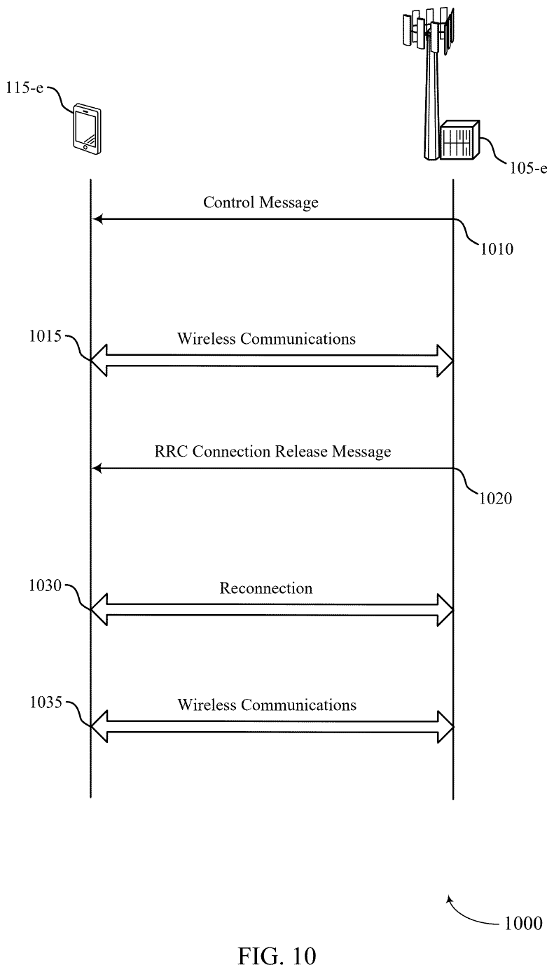

FIG. 10 shows an example of a process flow 1000 that supports UE capabilities and light adaptations in accordance with one or more aspects of the present disclosure. Aspects of the process flow 1000 may implement, or be implemented to realize, aspects of the wireless communications system 100, the wireless communications system 200, the wireless communications system 300, the timeline 400, the timeline 401, the wireless communications system 500, the timeline 600, the timeline 601, the state switching scheme 700, the process flow 800, and the process flow 900. For example, the process flow 1000 may include a UE 115-d (e.g., a UE, a UE 115, a UE 115-a, a UE 115-b, a UE 115-c, a UE 115-d, or other corresponding devices) and a network entity 105-d (e.g., a network entity, a network entity 105-a, a network entity 105-b, a network entity 105-c, a network entity 105-d, or other corresponding devices).

At 1010, the UE 115-e may receive a control message indicating at least a first state of two or more states corresponding to a BWP and a second state of the two or more states corresponding to the BWP, wherein each state is associated with a set of parameter values.

At 1015, the UE 115-e may engage in wireless communications. In some examples, the UE 115-e may communicate in accordance with the first state and a first set of parameter values associated with the first state, or the second state and a second set of parameter values associated with the first state in a RRC connected mode (e.g., as indicated by the network entity 105-e).

At 1020, the UE 115-e may receive a RRC connection release message indicating one of the states (e.g., the first state of two or more states).

At 1030 the UE 115-e may perform a reconnection procedure. In some examples, the UE may reconnect to a network entity according to the first state indicated in the connection release message.

At 1035, the UE 115-e may communicate according to the first state indicated in the connection release message (e.g., according to the reconnection procedure or the reconnecting).

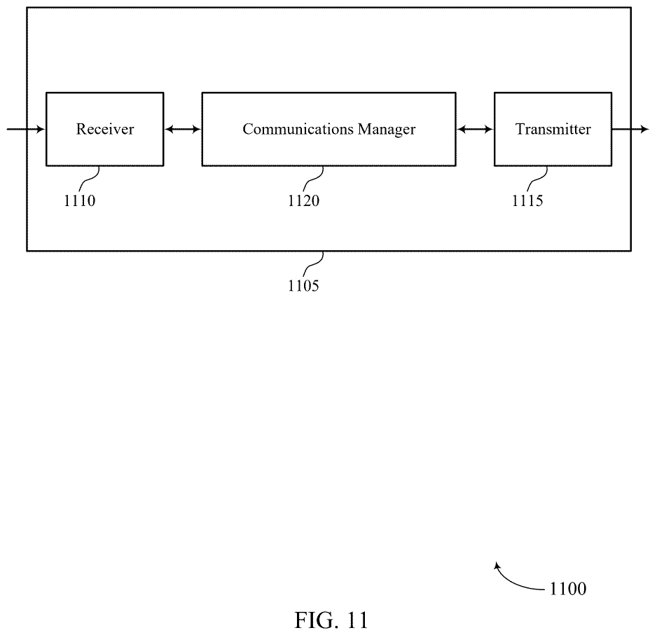

FIG. 11 shows a block diagram 1100 of a device 1105 that supports UE capabilities and light adaptations in accordance with one or more aspects of the present disclosure. The device 1105 may be an example of aspects of a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to the UE capability for light adaptation). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to the UE capability for light adaptation). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations or components thereof may be examples of means for performing various aspects of UE capabilities and light adaptations as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software) executed by at least one processor (e.g., referred to as a processor-executable code). Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting a capability message including an indication of timing information corresponding to an antenna switching procedure. The communications manager 1120 is capable of, configured to, or operable to support a means for receiving a control message indicating at least a first state corresponding to a BWP and a second state corresponding to the BWP, where the first state corresponds to a first quantity of antennas, and the second state corresponds to a second quantity of antennas. The communications manager 1120 is capable of, configured to, or operable to support a means for receiving, based on the capability message, a DCI message indicating the first state of the BWP. The communications manager 1120 is capable of, configured to, or operable to support a means for performing wireless communications via the BWP and at least the first quantity of antennas based on the DCI message, where a timing of the wireless communications is in accordance with the indication of timing information.

Additionally, or alternatively, the communications manager 1120 may support wireless communications in accordance with examples as disclosed herein. For example, the communications manager 1120 is capable of, configured to, or operable to support a means for transmitting a capability message indicating a set of parameters for which the UE supports switching between one or more states of a BWP. The communications manager 1120 is capable of, configured to, or operable to support a means for receiving a control message indicating at least a first state corresponding to the BWP and a second state corresponding to the BWP, where the first state corresponds to a first subset of one or more parameter values of the set of parameters, and the second state corresponds to a second subset of one or more parameter values of the set of parameters, based on the capability message. The communications manager 1120 is capable of, configured to, or operable to support a means for receiving, based on the capability message, a DCI message indicating the first state of the BWP. The communications manager 1120 is capable of, configured to, or operable to support a means for performing wireless communications via the BWP and using the first subset of one or more parameter values based on the DCI message.

Additionally, or alternatively, the communications manager 1120 may support wireless communications in accordance with examples as disclosed herein. For example, the communications manager 1120 is capable of, configured to, or operable to support a means for receiving a control message indicating at least a first state of two or more states corresponding to a BWP and a second state of the two or more states corresponding to the BWP, where each state is associated with a set of parameter values. The communications manager 1120 is capable of, configured to, or operable to support a means for communicating in accordance with the first state and a first set of parameter values or the second state and a second set of parameters in a RRC connected mode. The communications manager 1120 is capable of, configured to, or operable to support a means for receiving a RRC connection release message indicating a first state of two or more states. The communications manager 1120 is capable of, configured to, or operable to support a means for reconnecting to a network entity according to the first state indicated in the connection release message. The communications manager 1120 is capable of, configured to, or operable to support a means for communicating in accordance with the first state indicated in the connection release message in accordance with the reconnecting.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for light adaptation and capability reporting resulting in increased efficiency, reduced power consumption, more efficient use of available system resources, improved throughput, increased reliability of wireless signaling, and improved user experience.

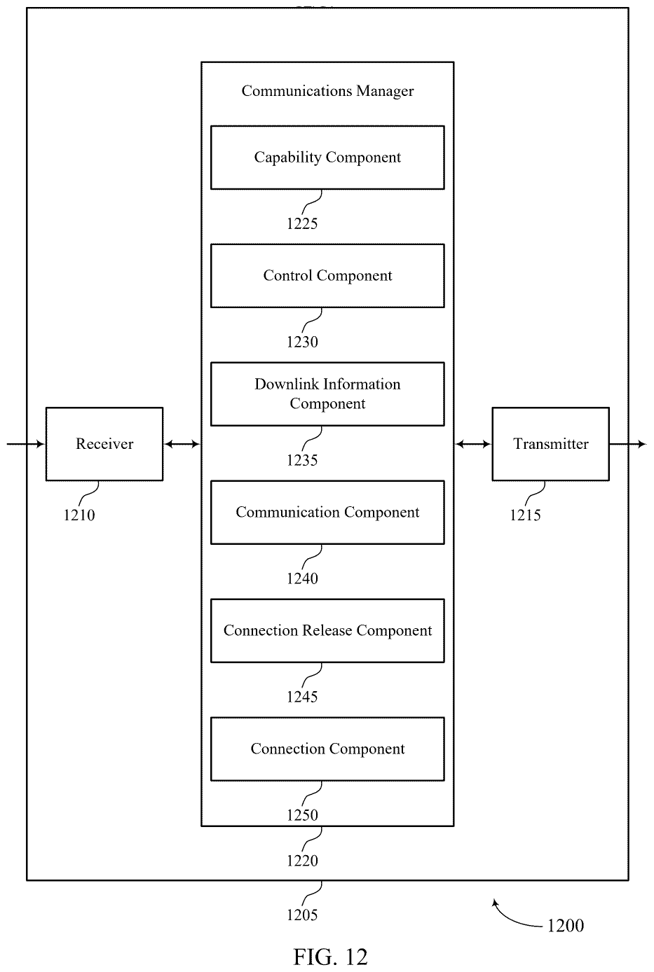

FIG. 12 shows a block diagram 1200 of a device 1205 that supports UE capabilities and light adaptations in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205, or one of more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to the UE capability for light adaptation). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to the UE capability for light adaptation). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of UE capabilities and light adaptations as described herein. For example, the communications manager 1220 may include a capability component 1225, a control component 1230, a downlink information component 1235, a communication component 1240, a connection release component 1245, a connection component 1250, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The capability component 1225 is capable of, configured to, or operable to support a means for transmitting a capability message including an indication of timing information corresponding to an antenna switching procedure. The control component 1230 is capable of, configured to, or operable to support a means for receiving a control message indicating at least a first state corresponding to a BWP and a second state corresponding to the BWP, where the first state corresponds to a first quantity of antennas, and the second state corresponds to a second quantity of antennas. The downlink information component 1235 is capable of, configured to, or operable to support a means for receiving, based on the capability message, a DCI message indicating the first state of the BWP. The communication component 1240 is capable of, configured to, or operable to support a means for performing wireless communications via the BWP and at least the first quantity of antennas based on the DCI message, where a timing of the wireless communications is in accordance with the indication of timing information.

Additionally, or alternatively, the communications manager 1220 may support wireless communications in accordance with examples as disclosed herein. The capability component 1225 is capable of, configured to, or operable to support a means for transmitting a capability message indicating a set of parameters for which the UE supports switching between one or more states of a BWP. The control component 1230 is capable of, configured to, or operable to support a means for receiving a control message indicating at least a first state corresponding to the BWP and a second state corresponding to the BWP, where the first state corresponds to a first subset of one or more parameter values of the set of parameters, and the second state corresponds to a second subset of one or more parameter values of the set of parameters, based on the capability message. The downlink information component 1235 is capable of, configured to, or operable to support a means for receiving, based on the capability message, a DCI message indicating the first state of the BWP. The communication component 1240 is capable of, configured to, or operable to support a means for performing wireless communications via the BWP and using the first subset of one or more parameter values based on the DCI message.

Additionally, or alternatively, the communications manager 1220 may support wireless communications in accordance with examples as disclosed herein. The control component 1230 is capable of, configured to, or operable to support a means for receiving a control message indicating at least a first state of two or more states corresponding to a BWP and a second state of the two or more states corresponding to the BWP, where each state is associated with a set of parameter values. The communication component 1240 is capable of, configured to, or operable to support a means for communicating in accordance with the first state and a first set of parameter values or the second state and a second set of parameters in a RRC connected mode. The connection release component 1245 is capable of, configured to, or operable to support a means for receiving a RRC connection release message indicating a first state of two or more states. The connection component 1250 is capable of, configured to, or operable to support a means for reconnecting to a network entity according to the first state indicated in the connection release message. The communication component 1240 is capable of, configured to, or operable to support a means for communicating in accordance with the first state indicated in the connection release message in accordance with the reconnecting.

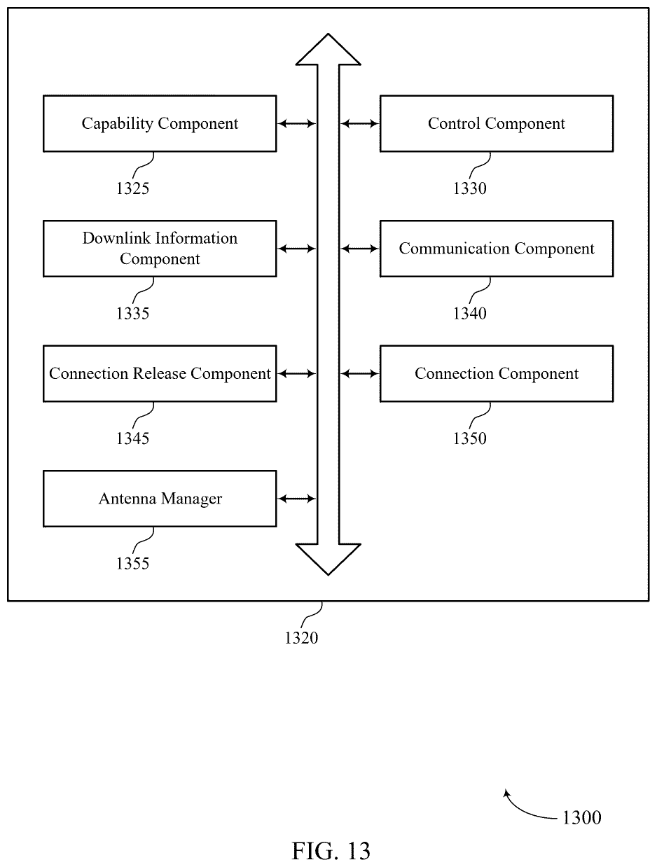

FIG. 13 shows a block diagram 1300 of a communications manager 1320 that supports UE capabilities and light adaptations in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of UE capabilities and light adaptations as described herein. For example, the communications manager 1320 may include a capability component 1325, a control component 1330, a downlink information component 1335, a communication component 1340, a connection release component 1345, a connection component 1350, an antenna manager 1355, or any combination thereof. Each of these components, or components or subcomponents thereof (e.g., one or more processors, one or more memories), may communicate, directly or indirectly, with one another (e.g., via one or more buses).

The communications manager 1320 may support wireless communications in accordance with examples as disclosed herein. The capability component 1325 is capable of, configured to, or operable to support a means for transmitting a capability message including an indication of timing information corresponding to an antenna switching procedure. The control component 1330 is capable of, configured to, or operable to support a means for receiving a control message indicating at least a first state corresponding to a BWP and a second state corresponding to the BWP, where the first state corresponds to a first quantity of antennas, and the second state corresponds to a second quantity of antennas. The downlink information component 1335 is capable of, configured to, or operable to support a means for receiving, based on the capability message, a DCI message indicating the first state of the BWP. The communication component 1340 is capable of, configured to, or operable to support a means for performing wireless communications via the BWP and at least the first quantity of antennas based on the DCI message, where a timing of the wireless communications is in accordance with the indication of timing information.

In some examples, the indication of timing information includes an indication of a first timeline of a set of candidate timelines. In some examples, the timing of the wireless communications is in accordance with the indicated first timeline.

In some examples, the antenna manager 1355 is capable of, configured to, or operable to support a means for setting a subset of antennas that are not utilized in the first state into a low power state based on the indication of the timing information, the subset of antennas including a difference between the first quantity of antennas and the second quantity of antennas, where an offset between receiving a grant of resources for the wireless communications and performing the wireless communications satisfies a threshold amount of time in accordance with the indication of the timing information.

In some examples, the indication of timing information includes at least one threshold offset value between receiving a grant of resources for the wireless communications and performing the wireless communications.

In some examples, the antenna manager 1355 is capable of, configured to, or operable to support a means for maintaining a subset of antennas that are not utilized in the first state into a low power state based on the indication of the timing information, the subset of antennas including a difference between the first quantity of antennas and the second quantity of antennas, where an offset between receiving a grant of resources for the wireless communications and performing the wireless communications satisfies a threshold amount of time in accordance with the indication of the timing information.

In some examples, the antenna manager 1355 is capable of, configured to, or operable to support a means for detecting that a delay corresponding to the wireless communications exceeds a threshold. In some examples, the antenna manager 1355 is capable of, configured to, or operable to support a means for transmitting a delay status report including an indication of updated timing information based on the detecting. In some examples, the antenna manager 1355 is capable of, configured to, or operable to support a means for performing additional wireless communications, where a timing of the additional wireless communications is in accordance with the indication of the updated timing information.

In some examples, the antenna manager 1355 is capable of, configured to, or operable to support a means for detecting that buffer status report or a logical channel priority exceeds a threshold. In some examples, the antenna manager 1355 is capable of, configured to, or operable to support a means for transmitting a delay status report including an indication of updated timing information based on the detecting. In some examples, the antenna manager 1355 is capable of, configured to, or operable to support a means for performing additional wireless communications, where a timing of the additional wireless communications is in accordance with the indication of the updated timing information.

In some examples, the antenna manager 1355 is capable of, configured to, or operable to support a means for transmitting a control message including an indication of updated timing information, where performing wireless communications is based on the updated timing information.

In some examples, the antenna manager 1355 is capable of, configured to, or operable to support a means for receive a control message including an indication of updated timing information, where performing wireless communications is based on the updated timing information.

Additionally, or alternatively, the communications manager 1320 may support wireless communications in accordance with examples as disclosed herein. In some examples, the capability component 1325 is capable of, configured to, or operable to support a means for transmitting a capability message indicating a set of parameters for which the UE supports switching between one or more states of a BWP. In some examples, the control component 1330 is capable of, configured to, or operable to support a means for receiving a control message indicating at least a first state corresponding to the BWP and a second state corresponding to the BWP, where the first state corresponds to a first subset of one or more parameter values of the set of parameters, and the second state corresponds to a second subset of one or more parameter values of the set of parameters, based on the capability message. In some examples, the downlink information component 1335 is capable of, configured to, or operable to support a means for receiving, based on the capability message, a DCI message indicating the first state of the BWP. In some examples, the communication component 1340 is capable of, configured to, or operable to support a means for performing wireless communications via the BWP and using the first subset of one or more parameter values based on the DCI message.

In some examples, the set of parameters include time domain parameters, frequency domain parameters, antenna domain parameters, or any combination thereof.

In some examples, the capability message further includes a bitmap, each codepoint of the bitmap corresponding to a candidate set of parameters of a set of multiple candidate sets of parameters.

In some examples, a first portion of the set of parameters corresponds to the first state, and a second portion of the set of parameters corresponds to the second state.

In some examples, the capability message includes an indication of whether the UE supports dynamic switching between states, semi-static switching between states, or both.

In some examples, the capability message includes an indication of a quantity of states corresponding to the BWP among which the UE is capable of switching, an indication of a threshold timing corresponding to switching among the quantity of states, or any combination thereof.

In some examples, the capability message includes an indication of one or more scheduling restrictions. In some examples, the one or more scheduling restrictions are based on respective slot types.

In some examples, the capability message includes an indication of a signaling type for which the UE supports switching among two or more states corresponding to the BWP while satisfying one or more scheduling restrictions.

In some examples, the capability message indicates one or more parameters that the UE supports for multiple states corresponding to the BWP.

In some examples, the control message indicates whether one or more scheduling thresholds apply to downlink communications, uplink communications, communications per band, or any combination thereof.

Additionally, or alternatively, the communications manager 1320 may support wireless communications in accordance with examples as disclosed herein. In some examples, the control component 1330 is capable of, configured to, or operable to support a means for receiving a control message indicating at least a first state of two or more states corresponding to a BWP and a second state of the two or more states corresponding to the BWP, where each state is associated with a set of parameter values. In some examples, the communication component 1340 is capable of, configured to, or operable to support a means for communicating in accordance with the first state and a first set of parameter values or the second state and a second set of parameters in a RRC connected mode. The connection release component 1345 is capable of, configured to, or operable to support a means for receiving a RRC connection release message indicating a first state of two or more states. The connection component 1350 is capable of, configured to, or operable to support a means for reconnecting to a network entity according to the first state indicated in the connection release message. In some examples, the communication component 1340 is capable of, configured to, or operable to support a means for communicating in accordance with the first state indicated in the connection release message in accordance with the reconnecting.

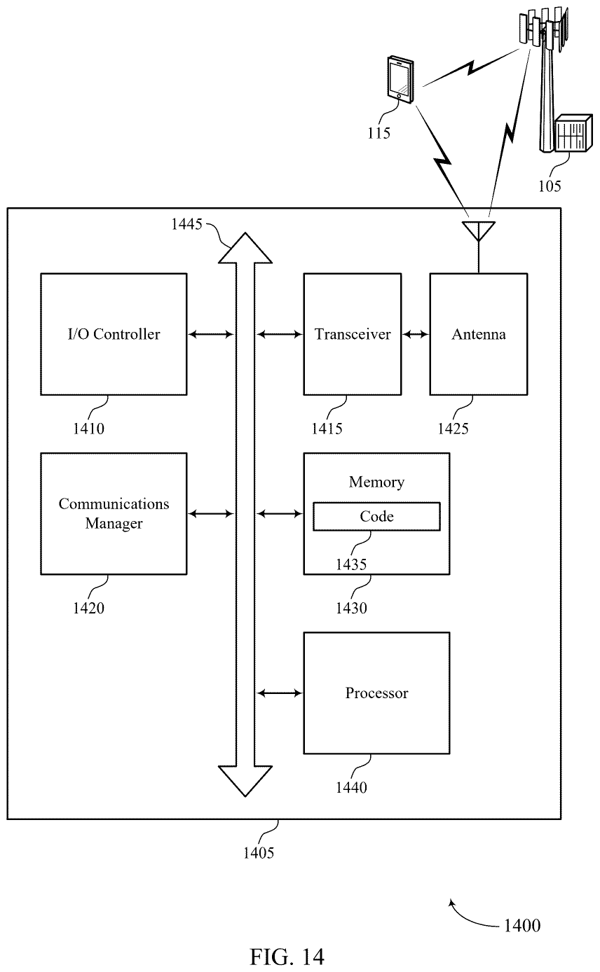

FIG. 14 shows a diagram of a system 1400 including a device 1405 that supports UE capabilities and light adaptation in accordance with one or more aspects of the present disclosure. The device 1405 may be an example of or include components of a device 1105, a device 1205, or a UE 115 as described herein. The device 1405 may communicate (e.g., wirelessly) with one or more other devices (e.g., network entities 105, UEs 115, or a combination thereof). The device 1405 may include components for bi-directional voice and data communications including components for transmitting and receiving communications, such as a communications manager 1420, an input/output (I/O) controller, such as an I/O controller 1410, a transceiver 1415, one or more antennas 1425, at least one memory 1430, code 1435, and at least one processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of one or more processors, such as the at least one processor 1440. In some cases, a user may interact with the device 1405 via the I/O controller 1410 or via hardware components controlled by the I/O controller 1410.

In some cases, the device 1405 may include a single antenna. However, in some other cases, the device 1405 may have more than one antenna, which may be capable of concurrently transmitting or receiving multiple wireless transmissions. The transceiver 1415 may communicate bi-directionally via the one or more antennas 1425 using wired or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The at least one memory 1430 may include random access memory (RAM) and read-only memory (ROM). The at least one memory 1430 may store computer-readable, computer-executable, or processor-executable code, such as the code 1435. The code 1435 may include instructions that, when executed by the at least one processor 1440, cause the device 1405 to perform various functions described herein. The code 1435 may be stored in a non-transitory computer-readable medium such as system memory or another type of memory. In some cases, the code 1435 may not be directly executable by the at least one processor 1440 but may cause a computer (e.g., when compiled and executed) to perform functions described herein. In some cases, the at least one memory 1430 may include, among other things, a basic I/O system (BIOS) which may control basic hardware or software operation such as the interaction with peripheral components or devices.

The at least one processor 1440 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1440 may be configured to operate a memory array using a memory controller. In some other cases, a memory controller may be integrated into the at least one processor 1440. The at least one processor 1440 may be configured to execute computer-readable instructions stored in a memory (e.g., the at least one memory 1430) to cause the device 1405 to perform various functions (e.g., functions or tasks supporting on the UE capability for light adaptation). For example, the device 1405 or a component of the device 1405 may include at least one processor 1440 and at least one memory 1430 coupled with or to the at least one processor 1440, the at least one processor 1440 and the at least one memory 1430 configured to perform various functions described herein.

In some examples, the at least one processor 1440 may include multiple processors and the at least one memory 1430 may include multiple memories. One or more of the multiple processors may be coupled with one or more of the multiple memories, which may, individually or collectively, be configured to perform various functions described herein. In some examples, the at least one processor 1440 may be a component of a processing system, which may refer to a system (such as a series) of machines, circuitry (including, for example, one or both of processor circuitry (which may include the at least one processor 1440) and memory circuitry (which may include the at least one memory 1430)), or components, that receives or obtains inputs and processes the inputs to produce, generate, or obtain a set of outputs. The processing system may be configured to perform one or more of the functions described herein. For example, the at least one processor 1440 or a processing system including the at least one processor 1440 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code 1435 (e.g., processor-executable code) stored in the at least one memory 1430 or otherwise, to perform one or more of the functions described herein.

The communications manager 1420 may support wireless communications in accordance with examples as disclosed herein. For example, the communications manager 1420 is capable of, configured to, or operable to support a means for transmitting a capability message including an indication of timing information corresponding to an antenna switching procedure. The communications manager 1420 is capable of, configured to, or operable to support a means for receiving a control message indicating at least a first state corresponding to a BWP and a second state corresponding to the BWP, where the first state corresponds to a first quantity of antennas, and the second state corresponds to a second quantity of antennas. The communications manager 1420 is capable of, configured to, or operable to support a means for receiving, based on the capability message, a DCI message indicating the first state of the BWP. The communications manager 1420 is capable of, configured to, or operable to support a means for performing wireless communications via the BWP and at least the first quantity of antennas based on the DCI message, where a timing of the wireless communications is in accordance with the indication of timing information.

Additionally, or alternatively, the communications manager 1420 may support wireless communications in accordance with examples as disclosed herein. For example, the communications manager 1420 is capable of, configured to, or operable to support a means for transmitting a capability message indicating a set of parameters for which the UE supports switching between one or more states of a BWP. The communications manager 1420 is capable of, configured to, or operable to support a means for receiving a control message indicating at least a first state corresponding to the BWP and a second state corresponding to the BWP, where the first state corresponds to a first subset of one or more parameter values of the set of parameters, and the second state corresponds to a second subset of one or more parameter values of the set of parameters, based on the capability message. The communications manager 1420 is capable of, configured to, or operable to support a means for receiving, based on the capability message, a DCI message indicating the first state of the BWP. The communications manager 1420 is capable of, configured to, or operable to support a means for performing wireless communications via the BWP and using the first subset of one or more parameter values based on the DCI message.

Additionally, or alternatively, the communications manager 1420 may support wireless communications in accordance with examples as disclosed herein. For example, the communications manager 1420 is capable of, configured to, or operable to support a means for receiving a control message indicating at least a first state of two or more states corresponding to a BWP and a second state of the two or more states corresponding to the BWP, where each state is associated with a set of parameter values. The communications manager 1420 is capable of, configured to, or operable to support a means for communicating in accordance with the first state and a first set of parameter values or the second state and a second set of parameters in a RRC connected mode. The communications manager 1420 is capable of, configured to, or operable to support a means for receiving a RRC connection release message indicating a first state of two or more states. The communications manager 1420 is capable of, configured to, or operable to support a means for reconnecting to a network entity according to the first state indicated in the connection release message. The communications manager 1420 is capable of, configured to, or operable to support a means for communicating in accordance with the first state indicated in the connection release message in accordance with the reconnecting.

By including or configuring the communications manager 1420 in accordance with examples as described herein, the device 1405 may support techniques for light adaptation and capability reporting resulting in increased efficiency, reduced power consumption, more efficient use of available system resources, improved throughput, increased reliability of wireless signaling, reduced processing, increased flexibility, decreased system latency, and improved user experience.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the at least one processor 1440, the at least one memory 1430, the code 1435, or any combination thereof. For example, the code 1435 may include instructions executable by the at least one processor 1440 to cause the device 1405 to perform various aspects of UE capabilities and light adaptation as described herein, or the at least one processor 1440 and the at least one memory 1430 may be otherwise configured to, individually or collectively, perform or support such operations.

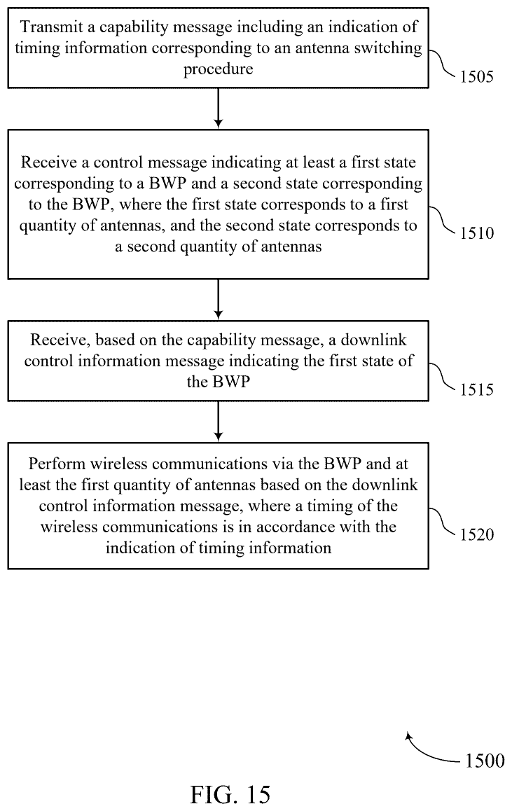

FIG. 15 shows a flowchart illustrating a method 1500 that supports UE capabilities and light adaptation in accordance with one or more aspects of the present disclosure. The operations of the method 1500 may be implemented by a UE or its components as described herein. For example, the operations of the method 1500 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1505, the method may include transmitting a capability message including an indication of timing information corresponding to an antenna switching procedure. The operations of 1505 may be performed in accordance with examples as disclosed herein. In some examples, aspects of the operations of 1505 may be performed by a capability component 1325 as described with reference to FIG. 13.

At 1510, the method may include receiving a control message indicating at least a first state corresponding to a BWP and a second state corresponding to the BWP, where the first state corresponds to a first quantity of antennas, and the second state corresponds to a second quantity of antennas. The operations of 1510 may be performed in accordance with examples as disclosed herein. In some examples, aspects of the operations of 1510 may be performed by a control component 1330 as described with reference to FIG. 13.

At 1515, the method may include receiving, based on the capability message, a DCI message indicating the first state of the BWP. The operations of 1515 may be performed in accordance with examples as disclosed herein. In some examples, aspects of the operations of 1515 may be performed by a downlink information component 1335 as described with reference to FIG. 13.

At 1520, the method may include performing wireless communications via the BWP and at least the first quantity of antennas based on the DCI message, where a timing of the wireless communications is in accordance with the indication of timing information. The operations of 1520 may be performed in accordance with examples as disclosed herein. In some examples, aspects of the operations of 1520 may be performed by a communication component 1340 as described with reference to FIG. 13.

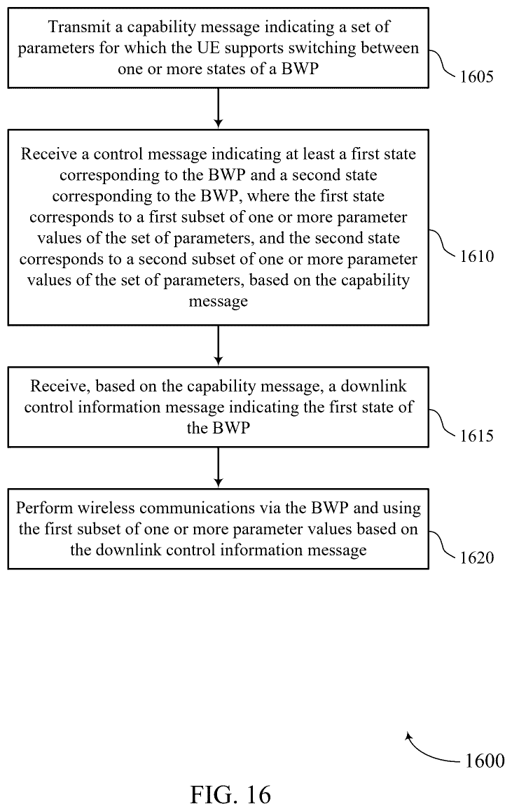

FIG. 16 shows a flowchart illustrating a method 1600 that supports UE capabilities and light adaptation in accordance with one or more aspects of the present disclosure. The operations of the method 1600 may be implemented by a UE or its components as described herein. For example, the operations of the method 1600 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1605, the method may include transmitting a capability message indicating a set of parameters for which the UE supports switching between one or more states of a BWP. The operations of 1605 may be performed in accordance with examples as disclosed herein. In some examples, aspects of the operations of 1605 may be performed by a capability component 1325 as described with reference to FIG. 13.

At 1610, the method may include receiving a control message indicating at least a first state corresponding to the BWP and a second state corresponding to the BWP, where the first state corresponds to a first subset of one or more parameter values of the set of parameters, and the second state corresponds to a second subset of one or more parameter values of the set of parameters, based on the capability message. The operations of 1610 may be performed in accordance with examples as disclosed herein. In some examples, aspects of the operations of 1610 may be performed by a control component 1330 as described with reference to FIG. 13.

At 1615, the method may include receiving, based on the capability message, a DCI message indicating the first state of the BWP. The operations of 1615 may be performed in accordance with examples as disclosed herein. In some examples, aspects of the operations of 1615 may be performed by a downlink information component 1335 as described with reference to FIG. 13.

At 1620, the method may include performing wireless communications via the BWP and using the first subset of one or more parameter values based on the DCI message. The operations of 1620 may be performed in accordance with examples as disclosed herein. In some examples, aspects of the operations of 1620 may be performed by a communication component 1340 as described with reference to FIG. 13.

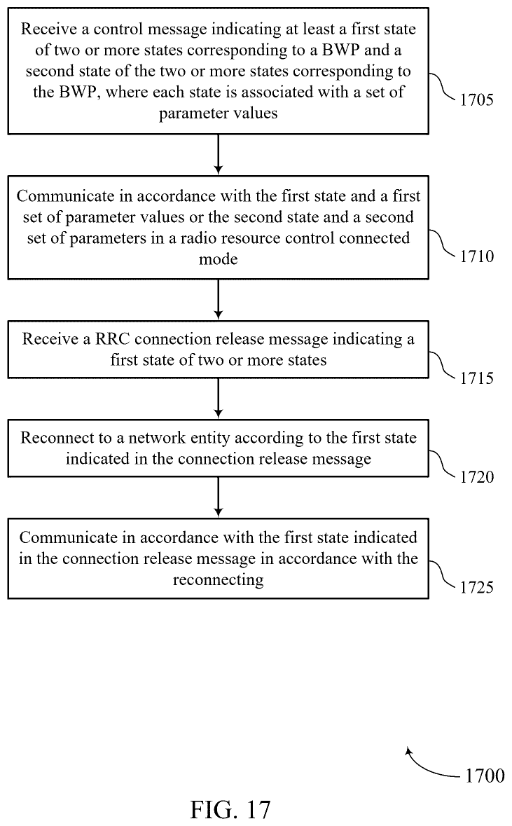

FIG. 17 shows a flowchart illustrating a method 1700 that supports UE capabilities and light adaptation in accordance with one or more aspects of the present disclosure. The operations of the method 1700 may be implemented by a UE or its components as described herein. For example, the operations of the method 1700 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1705, the method may include receiving a control message indicating at least a first state of two or more states corresponding to a BWP and a second state of the two or more states corresponding to the BWP, where each state is associated with a set of parameter values. The operations of 1705 may be performed in accordance with examples as disclosed herein. In some examples, aspects of the operations of 1705 may be performed by a control component 1330 as described with reference to FIG. 13.

At 1710, the method may include communicating in accordance with the first state and a first set of parameter values or the second state and a second set of parameters in a RRC connected mode. The operations of 1710 may be performed in accordance with examples as disclosed herein. In some examples, aspects of the operations of 1710 may be performed by a communication component 1340 as described with reference to FIG. 13.

At 1715, the method may include receiving a RRC connection release message indicating a first state of two or more states. The operations of 1715 may be performed in accordance with examples as disclosed herein. In some examples, aspects of the operations of 1715 may be performed by a connection release component 1345 as described with reference to FIG. 13.

At 1720, the method may include reconnecting to a network entity according to the first state indicated in the connection release message. The operations of 1720 may be performed in accordance with examples as disclosed herein. In some examples, aspects of the operations of 1720 may be performed by a connection component 1350 as described with reference to FIG. 13.

At 1725, the method may include communicating in accordance with the first state indicated in the connection release message in accordance with the reconnecting. The operations of 1725 may be performed in accordance with examples as disclosed herein. In some examples, aspects of the operations of 1725 may be performed by a communication component 1340 as described with reference to FIG. 13.

The following provides an overview of aspects of the present disclosure:

Aspect 1: A method for wireless communications at UE, comprising: transmitting a capability message including an indication of timing information corresponding to an antenna switching procedure; receiving a control message indicating at least a first state corresponding to a BWP and a second state corresponding to the BWP, wherein the first state corresponds to a first quantity of antennas, and the second state corresponds to a second quantity of antennas; receiving, based on the capability message, a DCI message indicating the first state of the BWP; and performing wireless communications via the BWP and at least the first quantity of antennas based at least in part on the DCI message, wherein a timing of the wireless communications is in accordance with the indication of timing information.

Aspect 2: The method of aspect 1, wherein the indication of timing information comprises an indication of a first timeline of a set of candidate timelines, and the timing of the wireless communications is in accordance with the indicated first timeline.

Aspect 3: The method of aspect 2, further comprising: setting a subset of antennas that are not utilized in the first state into a low power state based at least in part on the indication of the timing information, the subset of antennas comprising a difference between the first quantity of antennas and the second quantity of antennas, wherein an offset between receiving a grant of resources for the wireless communications and performing the wireless communications satisfies a threshold amount of time in accordance with the indication of the timing information.

Aspect 4: The method of any of aspects 1 through 3, wherein the indication of timing information comprises at least one threshold offset value between receiving a grant of resources for the wireless communications and performing the wireless communications.

Aspect 5: The method of aspect 4, further comprising: maintaining a subset of antennas that are not utilized in the first state into a low power state based at least in part on the indication of the timing information, the subset of antennas comprising a difference between the first quantity of antennas and the second quantity of antennas, wherein an offset between receiving a grant of resources for the wireless communications and performing the wireless communications satisfies a threshold amount of time in accordance with the indication of the timing information.

Aspect 6: The method of any of aspects 4 through 5, further comprising: detecting that a delay corresponding to the wireless communications exceeds a threshold; transmitting a delay status report comprising an indication of updated timing information based at least in part on the detecting; and performing additional wireless communications, wherein a timing of the additional wireless communications is in accordance with the indication of the updated timing information.

Aspect 7: The method of any of aspects 4 through 6, further comprising: detecting that buffer status report or a logical channel priority exceeds a threshold; transmitting a delay status report comprising an indication of updated timing information based at least in part on the detecting; and performing additional wireless communications, wherein a timing of the additional wireless communications is in accordance with the indication of the updated timing information.

Aspect 8: The method of any of aspects 1 through 7, further comprising: transmitting a control message comprising an indication of updated timing information, wherein performing wireless communications is based at least in part on the updated timing information.

Aspect 9: The method of any of aspects 1 through 8, further comprising: receive a control message comprising an indication of updated timing information, wherein performing wireless communications is based at least in part on the updated timing information.

Aspect 10: A method for wireless communications at UE, comprising: transmitting a capability message indicating a set of parameters for which the UE supports switching between one or more states of a BWP; receiving a control message indicating at least a first state corresponding to the BWP and a second state corresponding to the BWP, wherein the first state corresponds to a first subset of one or more parameter values of the set of parameters, and the second state corresponds to a second subset of one or more parameter values of the set of parameters, based at least in part on the capability message; receiving, based on the capability message, a DCI message indicating the first state of the BWP; and performing wireless communications via the BWP and using the first subset of one or more parameter values based at least in part on the DCI message.

Aspect 11: The method of aspect 10, wherein the set of parameters comprise time domain parameters, frequency domain parameters, antenna domain parameters, or any combination thereof.

Aspect 12: The method of any of aspects 10 through 11, wherein the capability message further comprises a bitmap, each codepoint of the bitmap corresponding to a candidate set of parameters of a plurality of candidate sets of parameters.

Aspect 13: The method of any of aspects 10 through 12, wherein a first portion of the set of parameters corresponds to the first state, and a second portion of the set of parameters corresponds to the second state.

Aspect 14: The method of any of aspects 10 through 13, wherein the capability message comprises an indication of whether the UE supports dynamic switching between states, semi-static switching between states, or both.

Aspect 15: The method of any of aspects 10 through 14, wherein the capability message comprises an indication of a quantity of states corresponding to the BWP among which the UE is capable of switching, an indication of a threshold timing corresponding to switching among the quantity of states, or any combination thereof.

Aspect 16: The method of any of aspects 10 through 15, wherein the capability message comprises an indication of one or more scheduling restrictions, the one or more scheduling restrictions are based on respective slot types.

Aspect 17: The method of aspect 16, wherein the capability message comprises an indication of a signaling type for which the UE supports switching among two or more states corresponding to the BWP while satisfying one or more scheduling restrictions.

Aspect 18: The method of any of aspects 10 through 17, wherein the capability message indicates one or more parameters that the UE supports for multiple states corresponding to the BWP.

Aspect 19: The method of any of aspects 10 through 18, wherein the control message indicates whether one or more scheduling thresholds apply to downlink communications, uplink communications, communications per band, or any combination thereof.

Aspect 20: A method for wireless communications at UE, comprising: receiving a control message indicating at least a first state of two or more states corresponding to a BWP and a second state of the two or more states corresponding to the BWP, wherein each state is associated with a set of parameter values; communicating in accordance with the first state and a first set of parameter values or the second state and a second set of parameters in a RRC connected mode; receiving a RRC connection release message indicating a first state of two or more states; reconnecting to a network entity according to the first state indicated in the connection release message; and communicating in accordance with the first state indicated in the connection release message in accordance with the reconnecting.

Aspect 21: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 9.

Aspect 22: A UE for wireless communications, comprising at least one means for performing a method of any of aspects 1 through 9.

Aspect 23: A non-transitory computer-readable medium storing code for wireless communications, the code comprising instructions executable by one or more processors (e.g., directly, indirectly, after pre-processing, without pre-processing) to perform a method of any of aspects 1 through 9.

Aspect 24: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 10 through 19.

Aspect 25: A UE for wireless communications, comprising at least one means for performing a method of any of aspects 10 through 19.

Aspect 26: A non-transitory computer-readable medium storing code for wireless communications, the code comprising instructions executable by one or more processors (e.g., directly, indirectly, after pre-processing, without pre-processing) to perform a method of any of aspects 10 through 19.

Aspect 27: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 20 through 20.

Aspect 28: A UE for wireless communications, comprising at least one means for performing a method of any of aspects 20 through 20.

Aspect 29: A non-transitory computer-readable medium storing code for wireless communications, the code comprising instructions executable by one or more processors to perform a method of any of aspects 20 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
one or more memories coupled to the at least one processor, the one or more memories storing instructions executable by the at least one processor, directly or after compilation, to cause the apparatus to:
transmit a capability message including an indication of timing information corresponding to an antenna switching procedure;
receive a control message indicating at least a first state corresponding to a bandwidth part and a second state corresponding to the bandwidth part, wherein the first state corresponds to a first quantity of antennas, and the second state corresponds to a second quantity of antennas;
receive, based on the capability message, a downlink control information message indicating the first state of the bandwidth part; and
perform wireless communications via the bandwidth part and at least the first quantity of antennas based at least in part on the downlink control information message, wherein a timing of the wireless communications is in accordance with the indication of timing information.

2. The UE of claim 1, wherein:
the indication of timing information comprises an indication of a first timeline of a set of candidate timelines, and
the timing of the wireless communications is in accordance with the indicated first timeline.

3. The UE of claim 2, wherein the at least one processor is individually or collectively further operable to execute the instructions to cause the UE to:
set a subset of antennas that are not utilized in the first state into a low power state based at least in part on the indication of the timing information, the subset of antennas comprising a difference between the first quantity of antennas and the second quantity of antennas, wherein an offset between receiving a grant of resources for the wireless communications and performing the wireless communications satisfies a threshold amount of time in accordance with the indication of the timing information.

4. The UE of claim 1, wherein the indication of timing information comprises at least one threshold offset value between receiving a grant of resources for the wireless communications and performing the wireless communications.

5. The UE of claim 4, wherein the at least one processor are individually or collectively further operable to execute the instructions to cause the UE to:
maintain a subset of antennas that are not utilized in the first state into a low power state based at least in part on the indication of the timing information, the subset of antennas comprising a difference between the first quantity of antennas and the second quantity of antennas, wherein an offset between receiving a grant of resources for the wireless communications and performing the wireless communications satisfies a threshold amount of time in accordance with the indication of the timing information.

6. The UE of claim 4, wherein the at least one processor is individually or collectively further operable to execute the instructions to cause the UE to:
detect that a delay corresponding to the wireless communications exceeds a threshold;
transmit a delay status report comprising an indication of updated timing information based at least in part on the detecting; and
perform additional wireless communications, wherein a timing of the additional wireless communications is in accordance with the indication of the updated timing information.

7. The UE of claim 4, wherein the at least one processor is individually or collectively further operable to execute the instructions to cause the UE to:
detect that buffer status report or a logical channel priority exceeds a threshold;
transmit a delay status report comprising an indication of updated timing information based at least in part on the detecting; and
perform additional wireless communications, wherein a timing of the additional wireless communications is in accordance with the indication of the updated timing information.

8. The UE of claim 1, wherein the at least one processor is individually or collectively further operable to execute the instructions to cause the UE to:
transmit a control message comprising an indication of updated timing information, wherein performing wireless communications is based at least in part on the updated timing information.

9. The UE of claim 1, wherein the at least one processor is individually or collectively further operable to execute the instructions to cause the UE to:
receive a control message comprising an indication of updated timing information, wherein performing wireless communications is based at least in part on the updated timing information.

10. An apparatus for wireless communications at a user equipment (UE), comprising:
at least one processor; and
one or more memories coupled to the at least one processor, the one or more memories storing instructions executable by the at least one processor, directly or after compilation, to cause the apparatus to:
transmit a capability message indicating a set of parameters for which the UE supports switching between one or more states of a bandwidth part;
receive a control message indicating at least a first state corresponding to the bandwidth part and a second state corresponding to the bandwidth part, wherein the first state corresponds to a first subset of one or more parameter values of the set of parameters, and the second state corresponds to a second subset of one or more parameter values of the set of parameters, based at least in part on the capability message;
receive, based on the capability message, a downlink control information message indicating the first state of the bandwidth part; and
perform wireless communications via the bandwidth part and using the first subset of one or more parameter values based at least in part on the downlink control information message.

11. The UE of claim 10, wherein the set of parameters comprise time domain parameters, frequency domain parameters, antenna domain parameters, or any combination thereof.

12. The UE of claim 10, wherein the capability message further comprises a bitmap, each codepoint of the bitmap corresponding to a candidate set of parameters of a plurality of candidate sets of parameters.

13. The UE of claim 10, wherein a first portion of the set of parameters corresponds to the first state, and a second portion of the set of parameters corresponds to the second state.

14. The UE of claim 10, wherein the capability message comprises an indication of whether the UE supports dynamic switching between states, semi-static switching between states, or both.

15. The UE of claim 10, wherein the capability message comprises an indication of a quantity of states corresponding to the bandwidth part among which the UE is capable of switching, an indication of a threshold timing corresponding to switching among the quantity of states, or any combination thereof.

16. The UE of claim 10, wherein the capability message comprises an indication of one or more scheduling restrictions, and the one or more scheduling restrictions are based on respective slot types.

17. The UE of claim 16, wherein the capability message comprises an indication of a signaling type for which the UE supports switching among two or more states corresponding to the bandwidth part while satisfying one or more scheduling restrictions.

18. The UE of claim 10, wherein the capability message indicates one or more parameters that the UE supports for multiple states corresponding to the bandwidth part.

19. The UE of claim 10, wherein the control message indicates whether one or more scheduling thresholds apply to downlink communications, uplink communications, communications per band, or any combination thereof.

20. An apparatus for wireless communications at a user equipment (UE), comprising:
at least one processor; and
one or more memories coupled to the at least one processor, the one or more memories storing instructions executable by the at least one processor, directly or after compilation, to cause the apparatus to:
receive a control message indicating at least a first state of two or more states corresponding to a bandwidth part and a second state of the two or more states corresponding to the bandwidth part, wherein each state is associated with a set of parameter values;
communicate in accordance with the first state and a first set of parameter values or the second state and a second set of parameters in a radio resource control connected mode;
receive a radio resource control connection release message indicating a first state of two or more states;
reconnect to a network entity according to the first state indicated in the connection release message; and
communicate in accordance with the first state indicated in the connection release message in accordance with the reconnecting.
